(19) United States
(12) Patent Application Publication
(10) Pub. No.: US 2017/0289566 A1
(43) Pub. Date: Oct. 5, 2017

(54) INTRA BLOCK COPY CODING WITH TEMPORAL BLOCK VECTOR PREDICTION

(71) Applicant: Vid Scale, Inc., Wilmington, DE (US)

(72) Inventors: Yuwen He, San Diego, CA (US); Yan Ye, San Diego, CA (US); Xiaoyu Xiu, San Diego, CA (US)

(73) Assignee: Vid Scale, Inc., Wilmington, DE (US)

(21) Appl. No.: 15/514,495

(22) PCT Filed: Sep. 18, 2015
(86) PCT No.: PCT/US2015/051001

§ 371 Date: Mar. 24, 2017

Related U.S. Application Data
(60) Provisional application No. 62/112,619, filed on Feb. 5, 2015.
(60) Provisional application No. 62/106,615, filed on Jan. 22, 2015.
(60) Provisional application No. 62/064,930, filed on Oct. 16, 2014.
(60) Provisional application No. 62/056,352, filed on Sep. 26, 2014.

(51) Int. Cl. H04N 19/52; H04N 19/70; H04N 19/176; H04N 19/11; H04N 19/147

(52) U.S. Cl. CPC H04N 19/52; H04N 19/11; H04N 19/147; H04N 19/176; H04N 19/70

(57) ABSTRACT

Embodiments disclosed herein operate to improve prior video coding techniques by incorporating an IntraBC flag explicitly at the prediction unit level in merge mode. This flag allows separate selection of block vector (BV) candidates and motion vector (MV) candidates. Specifically, explicit signaling of an IntraBC flag provides information on whether a specific prediction unit will use a BV or an MV. If the IntraBC flag is set, the candidate list is constructed using only spatial and temporal neighboring BVs. If the IntraBC flag is not set, the candidate list is constructed using only spatial and temporal neighboring MVs. An index is then coded which points into the list of candidate BVs or MVs. Further embodiments disclosed herein describe the use of BV-MV bi-prediction in a unified IntraBC and inter framework.

### CROSS-REFERENCE TO RELATED APPLICATION

The present application is a non-provisional filing of, and claims benefit under 35 U.S.C. §119(e) from, U.S. Provisional Patent Application Ser. No. 62/056,352, filed Sep. 26, 2014; U.S. Provisional Patent Application Ser. No. 62/064,930, filed Oct. 16, 2014; U.S. Provisional Patent Application Ser. No. 62/106,615, filed Jan. 22, 2015; and 62/112,619, filed Feb. 5, 2015. All of the foregoing are incorporated herein by reference in their entirety.

### BACKGROUND

Screen content sharing applications have become more and more popular in recent years with the desirability of remote desktop, video conferencing and mobile media presentation applications.

Compared to the natural video content, screen content can contain numerous blocks with several major colors and sharp edges because there are a lot of sharp curves and text in the screen content. Although existing video compression methods can be used to encode screen content and then transmit it to the receiver side, most existing methods do not fully characterize the features of screen content and therefore lead to a low compression performance. The reconstructed picture thus can have serious quality issues. For example, the curves and text can be blurred and difficult to recognize. Therefore, a well-designed screen compression method would be useful for effectively reconstructing screen content.

Screen content compression techniques are becoming increasingly important because more and more people are sharing their device content for media presentation or remote desktop purposes. The screen display of mobile devices has greatly increased to high definition or ultra-high definition resolutions. Existing video coding tools, such as block coding modes and transforms, are optimized for natural video encoding and not specially optimized for screen content encoding. Traditional video coding methods increase the bandwidth requirement for transmitting screen content in those sharing applications with some quality requirement settings.

### SUMMARY

Embodiments disclosed herein operate to improve prior video coding techniques by incorporating an IntraBC flag explicitly at the prediction unit level in merge mode. This flag allows separate selection of block vector (BV) candidates and motion vector (MV) candidates. Specifically, explicit signaling of an IntraBC flag provides information on whether a predictive vector used by a specific prediction is a BV or an MV. If the IntraBC flag is set, the candidate list is constructed using only neighboring BVs. If the IntraBC flag is not set, the candidate list is constructed using only neighboring MVs. An index is then coded which points into the list of candidate predictive vectors (BVs or MVs).

The generation of IntraBC merge candidates includes candidates from temporal reference pictures. As a result, it becomes possible to predict BVs across temporal distances. Accordingly, decoders according to embodiments of the present disclosure operate to store BVs for reference pictures. The BVs may be stored in a compressed form. Only a valid and unique BV is inserted in the candidate list.

In a unified IntraBC and inter framework, the BV from the collocated block in the temporal reference picture is included in the list of inter merge candidates. The default BVs are also appended if the list is not full. Only a valid BV and unique BV/MV is inserted in the list.

In an exemplary video coding method, a candidate block vector is identified for prediction of a first video block, where the first video block is in a current picture, and where the candidate block vector is a second block vector used for prediction of a second video block in a temporal reference picture. The first video block is coded with intra block copy coding using the candidate block vector as a predictor of the first video block. In some such embodiments, the coding of the first video block includes generating a bitstream encoding the current picture as a plurality of blocks of pixels, and wherein the bitstream includes an index identifying the second block vector. Some embodiments further include generating a merge candidate list, wherein the merge candidate list includes the second block vector, and wherein coding the first video block includes providing an index identifying the second block vector in the merge candidate list. The merge candidate list may further include at least one default block vector. In some embodiments, a merge candidate list is generated, where the merge candidate list includes a set of motion vector merge candidates and a set of block vector merge candidates. In such embodiments, the coding of the first video block may include providing the first video block with (i) a flag identifying that the predictor is in the set of block vector merge candidates and (ii) an index identifying the second block vector within the set of block vector merge candidates.

In another exemplary method, a slice of video is coded as a plurality of coding units, wherein each coding unit includes one or more prediction units and each coding unit corresponds to a portion of the video slice. For at least some of the prediction units, the coding may include forming a list of motion vector merge candidates and a list of block vector merge candidates. Based on the merge candidates and the prediction unit, one of the merge candidates is selected as a predictor. The prediction unit is provided with (i) a flag identifying whether the predictor is in the list of motion vector merge candidates or in the list of block vector merge candidates and (ii) an index identifying the predictor from within the identified list of merge candidates. At least one of the block vector merge candidates may be generated using temporal block vector prediction.

In a further exemplary method, a slice of video is as a plurality of coding units, wherein each coding unit includes one or more prediction units, and each coding unit corresponds to a portion of the video slice. For at least some of the prediction units, the coding may include forming a list of merge candidates, wherein each merge candidate is a predictive vector, and wherein at least one of the predictive vectors is a first block vector from a temporal reference picture.

Based on the merge candidates and the corresponding portion of the video slice, one of the merge candidates is selected as a predictor. The prediction unit is provided with an index identifying the predictor from within the identified set of merge candidates. In some such embodiments, the predictive vector is added to the list of merge candidates only after a determination is made that the predictive vector is valid and unique. In some embodiments, the list of merge candidates further includes at least one derived block vector. The selected predictor may be the first block vector, which in some embodiments may be a block vector associated with a collocated prediction unit. The collocated prediction unit may be in a collocated reference picture specified in the slice header.

In a further exemplary method, a slice of video is coded as a plurality of coding units, wherein each coding unit includes one or more prediction units, and each coding unit corresponds to a portion of the video slice. The coding in the exemplary method includes, for at least some of the prediction units, identifying a set of merge candidates, wherein the identification of the set of merge candidates includes adding at least one candidate with a default block vector. Based on the merge candidates and the corresponding portion of the video slice, one of the candidates is selected as a predictor. The prediction unit is provided with an index identifying the merge candidate from within the identified set of merge candidates. In some such methods, the default block vector is selected from a list of default block vectors.

In an exemplary video coding method, a candidate block vector is identified for prediction of a first video block, wherein the first video block is in a current picture, and wherein the candidate block vector is a second block vector used for prediction of a second video block in a temporal reference picture. The first video block is coded with intra block copy coding using the candidate block vector as a predictor of the first video block. In an exemplary method, the coding of the first video block includes receiving a flag associated with the first video block, where the flag identifies that the predictor is a block vector. Based on the receipt of the flag identifying that the predictor is a block vector, a merge candidate list is generated, where the merge candidate list includes a set of block vector merge candidates. An index is further received identifying the second block vector within the set of block vector merge candidates. Alternatively, for a video block in which a candidate motion vector is used for prediction, a flag is received, where the flag identifies that the predictor is a motion vector. Based on the receipt of the flag identifying that the predictor is a motion vector, a merge candidate list is generated, where the merge candidate list includes a set of motion vector merge candidates. An index is further received identifying the motion vector predictor within the set of motion vector merge candidates.

In some embodiments, encoder and/or decoder modules are employed to perform the methods described herein. Such modules may be implemented using a processor and non-transitory computer storage medium storing instructions operative to perform the methods described herein.

### BRIEF DESCRIPTION OF THE DRAWINGS

A more detailed understanding may be had from the following description, presented by way of example in conjunction with the accompanying drawings, which are first briefly described below.

FIG. 1 is a block diagram illustrating an example of a block-based video encoder.

FIG. 2 is a block diagram illustrating an example of a block-based video decoder.

FIG. 3 is a diagram of an example of eight directional prediction modes.

FIG. 4 is a diagram illustrating an example of 33 directional prediction modes and two non-directional prediction modes.

FIG. 5 is a diagram of an example of horizontal prediction.

FIG. 6 is a diagram of an example of the planar mode.

FIG. 7 is a diagram illustrating an example of motion prediction.

FIG. 8 is a diagram illustrating an example of block-level movement within a picture.

FIG. 9 is a diagram illustrating an example of a coded bitstream structure.

FIG. 10 is a diagram illustrating an example communication system.

FIG. 11 is a diagram illustrating an example wireless transmit/receive unit (WTRU).

FIG. 12 is a schematic block diagram illustrating a screen content sharing system.

FIG. 13 illustrates a full-frame intra-block copy mode in which block x is the current coding block.

FIG. 14 illustrates a local region intra block copy mode in which only the left CTU and current CTU are allowed.

FIG. 15 illustrates spatial and temporal MV predictors for inter MV prediction.

FIG. 16 is a flow diagram illustrating temporal motion vector prediction.

FIG. 17 is a flow diagram illustrating reference list selection of the collocated block.

FIG. 18 illustrates an implementation in which IntraBC mode is signaled as inter mode. To code the current picture Pic(t), the already-coded part of the current picture before deblocking and sample adaptive offset (SAO), denoted as Pic′(t), is added in reference list_0 as a long term reference picture. All other reference pictures Pic(t−1), Pic(t−3), Pic(t+1), Pic(t+5) are regular temporal reference pictures that have been processed with deblocking and SAO.

FIG. 19 illustrates spatial BV predictors used for BV prediction.

FIGS. 20A and 20B are flowcharts of a temporal BV predictor derivation (TBVD) process, in which cBlock is the block to be checked and rBV is the returned block vector. A BV of (0,0) is invalid. FIG. 20A illustrates TBVD using one reference picture, and FIG. 20B illustrates TBVD using four reference pictures.

FIG. 21 is a flow chart illustrating a method of temporal BV predictor generation for BV prediction.

FIG. 22 illustrates spatial candidates for IntraBC merge.

FIGS. 23A and 23B illustrate IntraBC merge candidates derivation. Blocks C0 and C2 are IntraBC blocks, blocks C1 and C3 are inter blocks, and block C4 is an intra/palette block. FIG. 23A illustrates IBC merge candidates derivation using one collocated reference picture for temporal block vector prediction (TBVP). FIG. 23B illustrates IBC merge candidates derivation using four temporal reference pictures for TBVP.

FIGS. 24A and 24B together form a flow diagram illustrating an IntraBC merge BV candidate generation process according to some embodiments.

FIG. 25 is a flow diagram illustrating temporal BV candidate derivation for IntraBC merge mode.

FIG. 26 is a schematic illustration of spatial neighbors used in deriving spatial merge candidates in the HEVC merge process.

FIG. 27 is a diagram illustrating an example of block vector derivation.

FIG. 28 is a diagram illustrating an example of motion vector derivation.

FIGS. 29A and 29B together provide a flow chart illustrating bi-prediction search for BV-MV bi-prediction mode.

FIG. 30 is a flow chart illustrating updating of the target block for the BV/MV refinement in bi-prediction search.

FIGS. 31A and 31B illustrate search windows for BV refinement (31A) and MV_refinement (31B).

### DETAILED DESCRIPTION

### I. Video Coding.

A detailed description of illustrative embodiments will now be provided with reference to the various Figures. Although this description provides detailed examples of possible implementations, it should be noted that the provided details are intended to be by way of example and in no way limit the scope of the application.

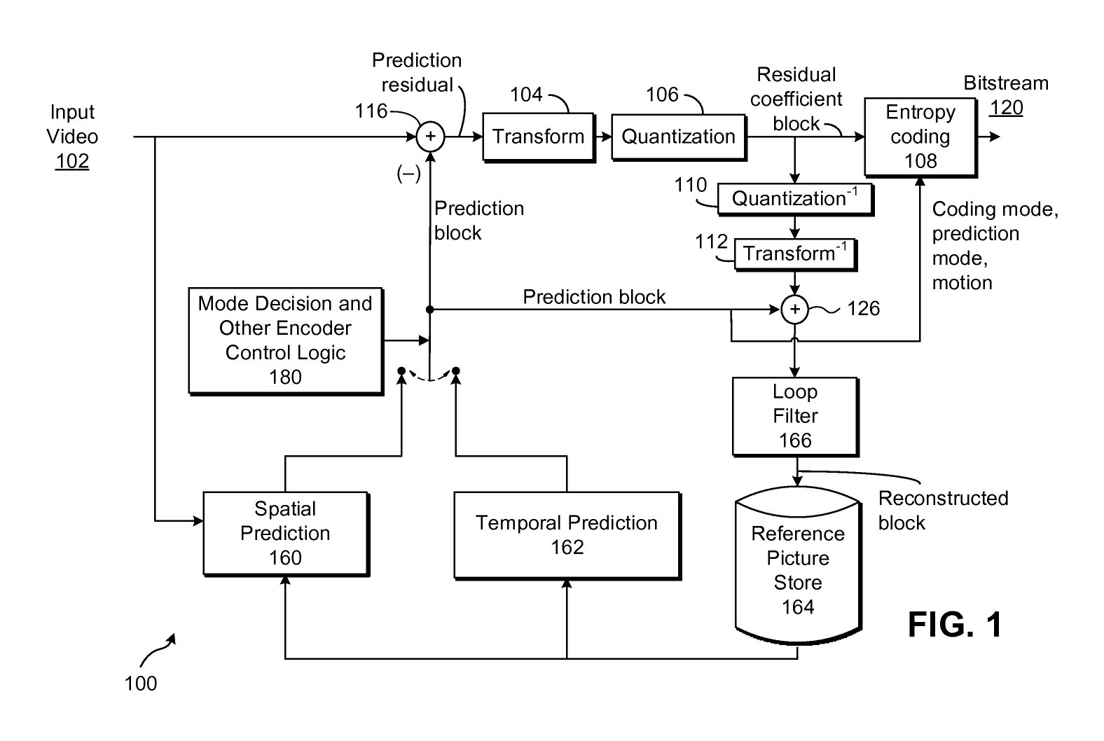

FIG. 1 is a block diagram illustrating an example of a block-based video encoder, for example, a hybrid video encoding system. The video encoder 100 may receive an input video signal 102. The input video signal 102 may be processed block by block. A video block may be of any size. For example, the video block unit may include 16×16 pixels. A video block unit of 16×16 pixels may be referred to as a macroblock (MB). In High Efficiency Video Coding (HEVC), extended block sizes (e.g., which may be referred to as a coding tree unit (CTU) or a coding unit (CU), two terms which are equivalent for purposes of this disclosure) may be used to efficiently compress high-resolution (e.g., 1080p and beyond) video signals. In HEVC, a CU may be up to 64×64 pixels. A CU may be partitioned into prediction units (PUs), for which separate prediction methods may be applied.

For an input video block (e.g., an MB or a CU), spatial prediction 160 and/or temporal prediction 162 may be performed. Spatial prediction (e.g., “intra prediction”) may use pixels from already coded neighboring blocks in the same video picture/slice to predict the current video block. Spatial prediction may reduce spatial redundancy inherent in the video signal. Temporal prediction (e.g., “inter prediction” or “motion compensated prediction”) may use pixels from already coded video pictures (e.g., which may be referred to as “reference pictures”) to predict the current video block. Temporal prediction may reduce temporal redundancy inherent in the video signal. A temporal prediction signal for a video block may be signaled by one or more motion vectors, which may indicate the amount and/or the direction of motion between the current block and its prediction block in the reference picture. If multiple reference pictures are supported (e.g., as may be the case for H.264/AVC and/or HEVC), then for a video block, its reference picture index may be sent. The reference picture index may be used to identify from which reference picture in a reference picture store 164 the temporal prediction signal comes.

The mode decision block 180 in the encoder may select a prediction mode, for example, after spatial and/or temporal prediction. The prediction block may be subtracted from the current video block at 116. The prediction residual may be transformed 104 and/or quantized 106. The quantized residual coefficients may be inverse quantized 110 and/or inverse transformed 112 to form the reconstructed residual, which may be added back to the prediction block 126 to form the reconstructed video block.

In-loop filtering (e.g., a deblocking filter, a sample adaptive offset, an adaptive loop filter, and/or the like) may be applied 166 to the reconstructed video block before it is put in the reference picture store 164 and/or used to code future video blocks. The video encoder 100 may output an output video stream 120. To form the output video bitstream 120, a coding mode (e.g., inter prediction mode or intra prediction mode), prediction mode information, motion information, and/or quantized residual coefficients may be sent to the entropy coding unit 108 to be compressed and/or packed to form the bitstream. The reference picture store 164 may be referred to as a decoded picture buffer (DPB).

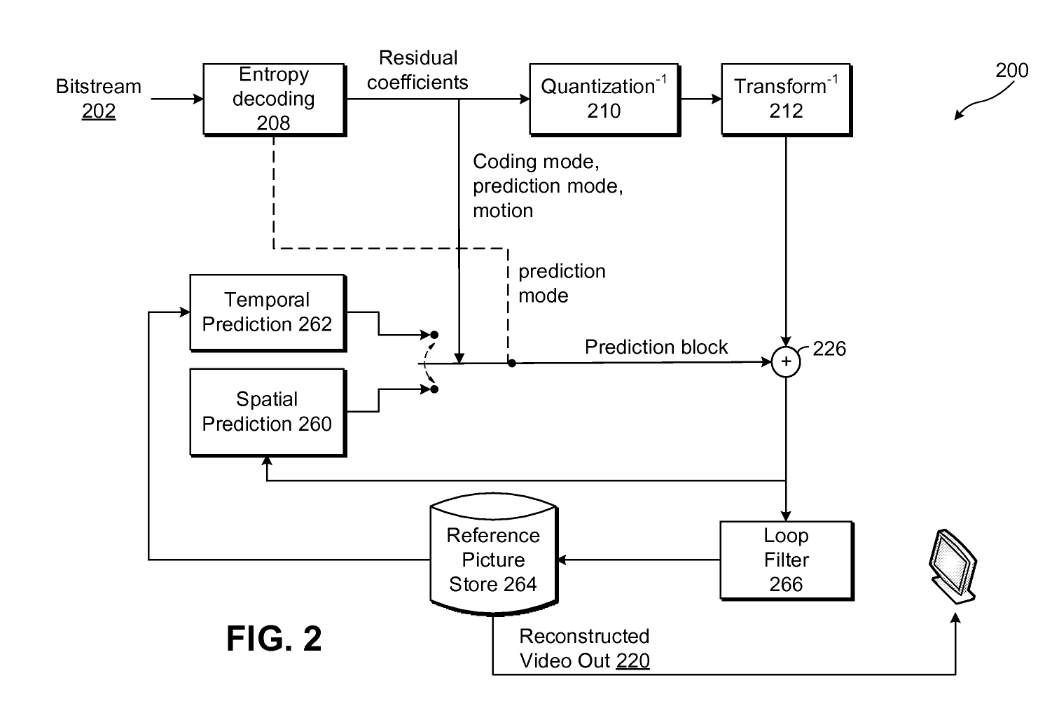

FIG. 2 is a block diagram illustrating an example of a block-based video decoder. The video decoder 200 may receive a video bitstream 202. The video bitstream 202 may be unpacked and/or entropy decoded at entropy decoding unit 208. The coding mode and/or prediction information used to encode the video bitstream may be sent to the spatial prediction unit 260 (e.g., if intra coded) and/or the temporal prediction unit 262 (e.g., if inter coded) to form a prediction block. If inter coded, the prediction information may comprise prediction block sizes, one or more motion vectors (e.g., which may indicate direction and amount of motion), and/or one or more reference indices (e.g., which may indicate from which reference picture to obtain the prediction signal). Motion-compensated prediction may be applied by temporal prediction unit 262 to form a temporal prediction block.

The residual transform coefficients may be sent to an inverse quantization unit 210 and an inverse transform unit 212 to reconstruct the residual block. The prediction block and the residual block may be added together at 226. The reconstructed block may go through in-loop filtering 266 before it is stored in reference picture store 264. The reconstructed video in the reference picture store 264 may be used to drive a display device and/or used to predict future video blocks. The video decoder 200 may output a reconstructed video signal 220. The reference picture store 264 may also be referred to as a decoded picture buffer (DPB).

A video encoder and/or decoder (e.g., video encoder 100 or video decoder 200) may perform spatial prediction (e.g., which may be referred to as intra prediction). Spatial prediction may be performed by predicting from already coded neighboring pixels following one of a plurality of prediction directions (e.g., which may be referred to as directional intra prediction).

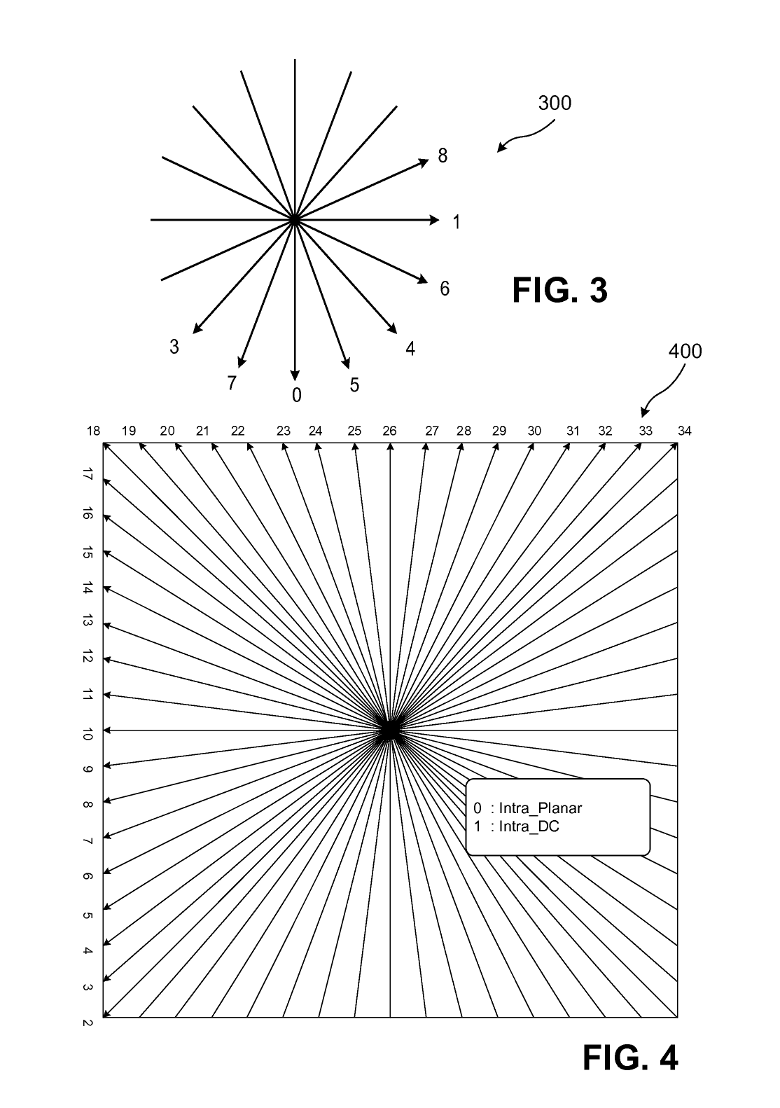

FIG. 3 is a diagram of an example of eight directional prediction modes. The eight directional prediction modes of FIG. 3 may be supported in H.264/AVC. As shown generally at 300 in FIG. 3, the nine modes (including DC mode 2) are:
Mode 0: Vertical Prediction
Mode 1: Horizontal prediction
Mode 2: DC prediction
Mode 3: Diagonal down-left prediction
Mode 4: Diagonal down-right prediction
Mode 5: Vertical-right prediction
Mode 6: Horizontal-down prediction
Mode 7: Vertical-left prediction
Mode 8: Horizontal-up prediction

Spatial prediction may be performed on a video block of various sizes and/or shapes. Spatial prediction of a luma component of a video signal may be performed, for example, for block sizes of 4×4, 8×8, and 16×16 pixels (e.g., in H.264/AVC). Spatial prediction of a chroma component of a video signal may be performed, for example, for block size of 8×8 (e.g., in H.264/AVC). For a luma block of size 4×4 or 8×8, a total of nine prediction modes may be supported, for example, eight directional prediction modes and the DC mode (e.g., in H.264/AVC). Four prediction modes may be supported; horizontal, vertical, DC, and planar prediction, for example, for a luma block of size 16×16.

Furthermore, directional intra prediction modes and non-directional prediction modes may be supported.

FIG. 4 is a diagram illustrating an example of 33 directional prediction modes and two non-directional prediction modes. The 33 directional prediction modes and two non-directional prediction modes, shown generally at 400 in FIG. 4, may be supported by HEVC. Spatial prediction using larger block sizes may be supported. For example, spatial prediction may be performed on a block of any size, for example, of square block sizes of 4×4, 8×8, 16×16, 32×32, or 64×64. Directional intra prediction (e.g., in HEVC) may be performed with 1/32-pixel precision.

Non-directional intra prediction modes may be supported (e.g., in H.264/AVC, HEVC, or the like), for example, in addition to directional intra prediction. Non-directional intra prediction modes may include the DC mode and/or the planar mode. For the DC mode, a prediction value may be obtained by averaging the available neighboring pixels and the prediction value may be applied to the entire block uniformly. For the planar mode, linear interpolation may be used to predict smooth regions with slow transitions. H.264/AVC may allow for use of the planar mode for 16×16 luma blocks and chroma blocks.

An encoder (e.g., the encoder 100) may perform a mode decision (e.g., at block 180 in FIG. 1) to determine the best coding mode for a video block. When the encoder determines to apply intra prediction (e.g., instead of inter prediction), the encoder may determine an optimal intra prediction mode from the set of available modes. The selected directional intra prediction mode may offer strong hints as to the direction of any texture, edge, and/or structure in the input video block.

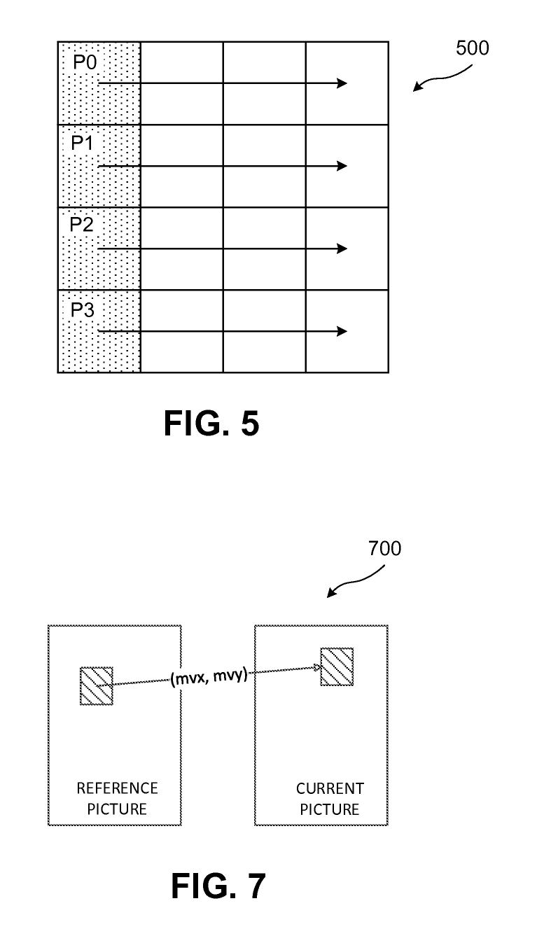

FIG. 5 is a diagram of an example of horizontal prediction (e.g., for a 4×4 block), as shown generally at 500 in FIG. 5. Already reconstructed pixels P0, P1, P2 and P3 (i.e., the shaded boxes) may be used to predict the pixels in the current 4×4 video block. In horizontal prediction, a reconstructed pixel, for example, pixels P0, P1, P2 and/or P3, may be propagated horizontally along the direction of a corresponding row to predict the 4×4 block. For example, prediction may be performed according to Equation (1) below, where L(x,y) may be the pixel to be predicted at (x,y), x,y=0 . . . 3.

L(x,0)=P0

L(x,1)=P1

L(x,2)=P2

L(x,3)=P3 (1)

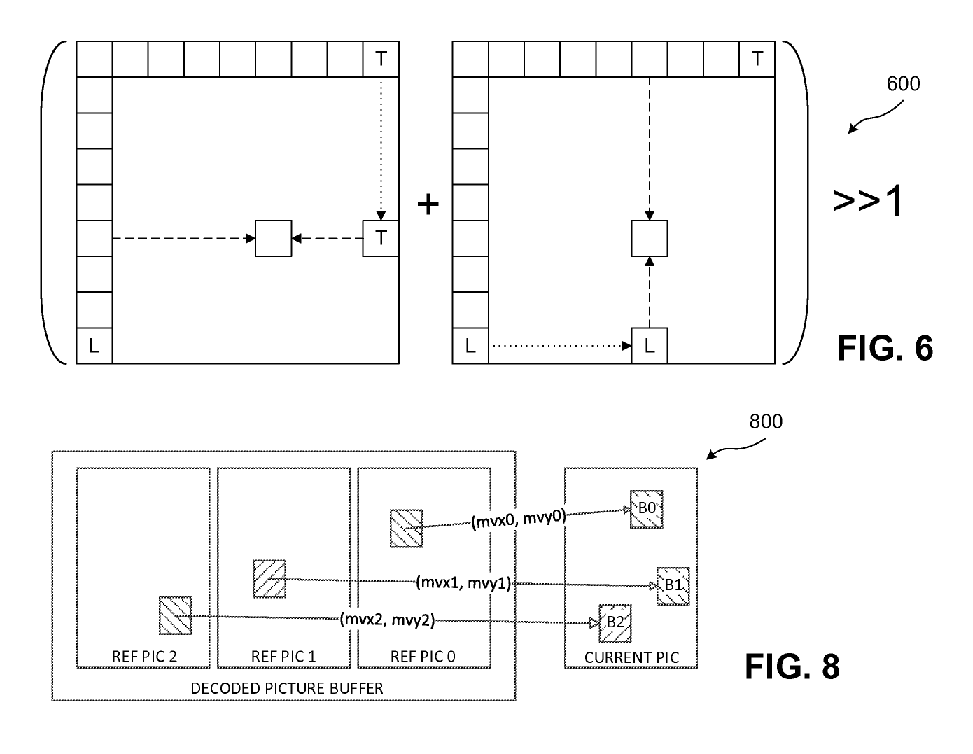

FIG. 6 is a diagram of an example of the planar mode, as shown generally at 600 in FIG. 6. The planar mode may be performed accordingly: the rightmost pixel in the top row (marked by a T) may be replicated to predict pixels in the rightmost column. The bottom pixel in the left column (marked by an L) may be replicated to predict pixels in the bottom row. Bilinear interpolation in the horizontal direction (as shown in the left block) may be performed to produce a first prediction H(x,y) of center pixels. Bilinear interpolation in the vertical direction (e.g., as shown in the right block) may be performed to produce a second prediction V(x,y) of center pixels. An averaging between the horizontal prediction and the vertical prediction may be performed to obtain a final prediction L(x,y), using L(x,y)=((H(x,y)+V(x,y))>>1).

FIG. 7 and FIG. 8 are diagrams illustrating, as shown generally at 700 and 800, an example of motion prediction of video blocks (e.g., using temporal prediction unit 162 of FIG. 1). FIG. 8, which illustrates an example of block-level movement within a picture, is a diagram illustrating an example decoded picture buffer including, for example, reference pictures “Ref pic 0,” “Ref pic 1,” and “Ref pic2.” The blocks B0, B1, and B2 in a current picture may be predicted from blocks in reference pictures “Ref pic 0,” “Ref pic 1,” and “Ref pic2” respectively. Motion prediction may use video blocks from neighboring video frames to predict the current video block. Motion prediction may exploit temporal correlation and/or remove temporal redundancy inherent in the video signal. For example, in H.264/AVC and HEVC, temporal prediction may be performed on video blocks of various sizes (e.g., for the luma component, temporal prediction block sizes may vary from 16×16 to 4×4 in H.264/AVC, and from 64×64 to 4×4 in HEVC). With a motion vector of (mvx, mvy), temporal prediction may be performed as provided by equation (2):

P(x,y)=ref(x−mvx,y−mvy) (2)

where ref(x,y) may be pixel value at location (x,y) in the reference picture, and P(x,y) may be the predicted block. A video coding system may support inter-prediction with fractional pixel precision. When a motion vector (mvx, mvy) has fractional pixel value, one or more interpolation filters may be applied to obtain the pixel values at fractional pixel positions. Block based video coding systems may use multi-hypothesis prediction to improve temporal prediction, for example, where a prediction signal may be formed by combining a number of prediction signals from different reference pictures. For example, H.264/AVC and/or HEVC may use bi-prediction that may combine two prediction signals. Bi-prediction may combine two prediction signals, each from a reference picture, to form a prediction, such as the following equation (3):

$$P ( x , y ) = \frac{{P}_{0} ( x , y ) + {P}_{1} ( x , y )}{2} = \frac{{ref}_{0} ( x - {mvx}_{0} , y - {mvy}_{0} ) + {ref}_{1} ( x - {mvx}_{1} , y - {mvy}_{1} )}{2} \qquad ( 3 )$$

where P₀(x,y) and P₁(x,y) may be the first and the second prediction block, respectively. As illustrated in equation (3), the two prediction blocks may be obtained by performing motion-compensated prediction from two reference pictures ref₀(x,y) and ref₁(x,y), with two motion vectors (mvx₀,mvy₀) and (mvx₁,mvy₁) respectively. The prediction block P(x,y) may be subtracted from the source video block (e.g., at 116) to form a prediction residual block. The prediction residual block may be transformed (e.g., at transform unit 104) and/or quantized (e.g., at quantization unit 106). The quantized residual transform coefficient blocks may be sent to an entropy coding unit (e.g., entropy coding unit 108) to be entropy coded to reduce bit rate. The entropy coded residual coefficients may be packed to form part of an output video bitstream (e.g., bitstream 120).

A single layer video encoder may take a single video sequence input and generate a single compressed bit stream transmitted to the single layer decoder. A video codec may be designed for digital video services (e.g., such as but not limited to sending TV signals over satellite, cable and terrestrial transmission channels). With video centric applications deployed in heterogeneous environments, multi-layer video coding technologies may be developed as an extension of the video coding standards to enable various applications. For example, multiple layer video coding technologies, such as scalable video coding and/or multi-view video coding, may be designed to handle more than one video layer where each layer may be decoded to reconstruct a video signal of a particular spatial resolution, temporal resolution, fidelity, and/or view. Although a single layer encoder and decoder are described with reference to FIG. 1 and FIG. 2, the concepts described herein may utilize a multiple layer encoder and/or decoder, for example, for multi-view and/or scalable coding technologies.

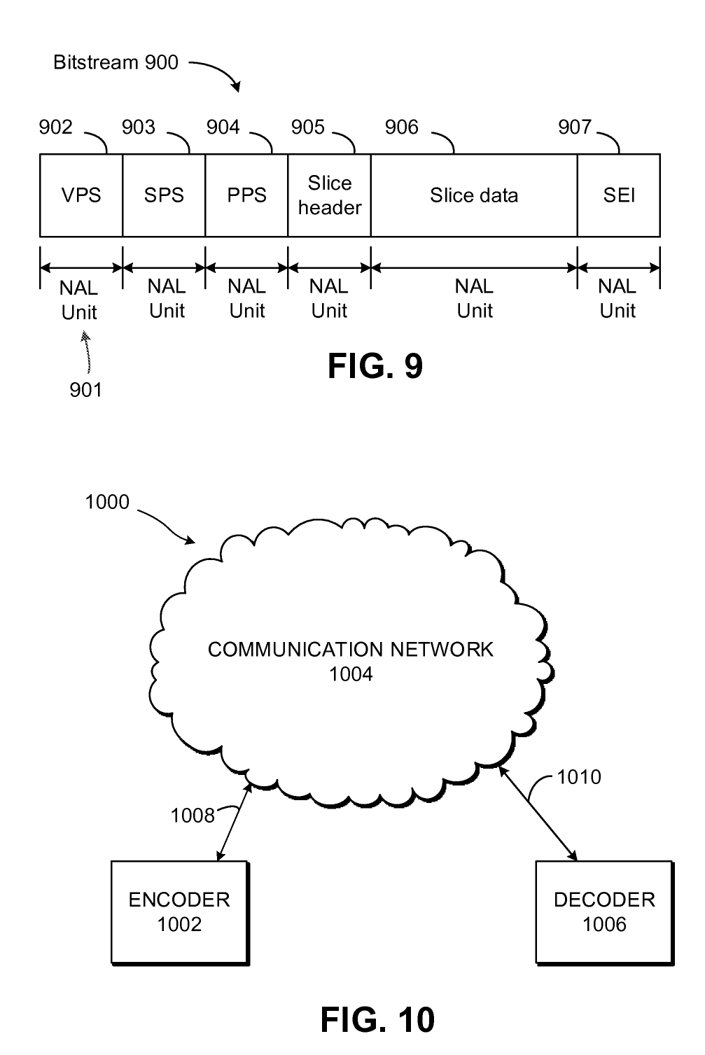

FIG. 9 is a diagram illustrating an example of a coded bitstream structure. A coded bitstream 900 consists of a number of NAL (Network Abstraction layer) units 901. A NAL unit may contain coded sample data such as coded slice 906, or high level syntax metadata such as parameter set data, slice header data 905 or supplemental enhancement information data 907 (which may be referred to as an SEI message). Parameter sets are high level syntax structures containing essential syntax elements that may apply to multiple bitstream layers (e.g. video parameter set 902 (VPS)), or may apply to a coded video sequence within one layer (e.g. sequence parameter set 903 (SPS)), or may apply to a number of coded pictures within one coded video sequence (e.g. picture parameter set 904 (PPS)). The parameter sets can be either sent together with the coded pictures of the video bit stream, or sent through other means (including out-of-band transmission using reliable channels, hard coding, etc.). Slice header 905 is also a high level syntax structure that may contain some picture-related information that is relatively small or relevant only for certain slice or picture types. SEI messages 907 carry the information that may not be needed by the decoding process but can be used for various other purposes such as picture output timing or display as well as loss detection and concealment.

FIG. 10 is a diagram illustrating an example of a communication system. The communication system 1000 may comprise an encoder 1002, a communication network 1004, and a decoder 1006. The encoder 1002 may be in communication with the network 1004 via a connection 1008, which may be a wireline connection or a wireless connection. The encoder 1002 may be similar to the block-based video encoder of FIG. 1. The encoder 1402 may include a single layer codec (e.g., FIG. 1) or a multilayer codec. The decoder 1006 may be in communication with the network 1004 via a connection 1010, which may be a wireline connection or a wireless connection. The decoder 1006 may be similar to the block-based video decoder of FIG. 2. The decoder 1006 may include a single layer codec (e.g., FIG. 2) or a multilayer codec.

The encoder 1002 and/or the decoder 1006 may be incorporated into a wide variety of wired communication devices and/or wireless transmit/receive units (WTRUs), such as, but not limited to, digital televisions, wireless broadcast systems, a network element/terminal, servers, such as content or web servers (e.g., such as a Hypertext Transfer Protocol (HTTP) server), personal digital assistants (PDAs), laptop or desktop computers, tablet computers, digital cameras, digital recording devices, video gaming devices, video game consoles, cellular or satellite radio telephones, digital media players, and/or the like.

The communications network 1004 may be a suitable type of communication network. For example, the communications network 1004 may be a multiple access system that provides content, such as voice, data, video, messaging, broadcast, etc., to multiple wireless users. The communications network 1004 may enable multiple wireless users to access such content through the sharing of system resources, including wireless bandwidth. For example, the communications network 1004 may employ one or more channel access methods, such as code division multiple access (CDMA), time division multiple access (TDMA), frequency division multiple access (FDMA), orthogonal FDMA (OFDMA), single-carrier FDMA (SC-FDMA), and/or the like. The communication network 1004 may include multiple connected communication networks. The communication network 1004 may include the Internet and/or one or more private commercial networks such as cellular networks, WiFi hotspots, Internet Service Provider (ISP) networks, and/or the like.

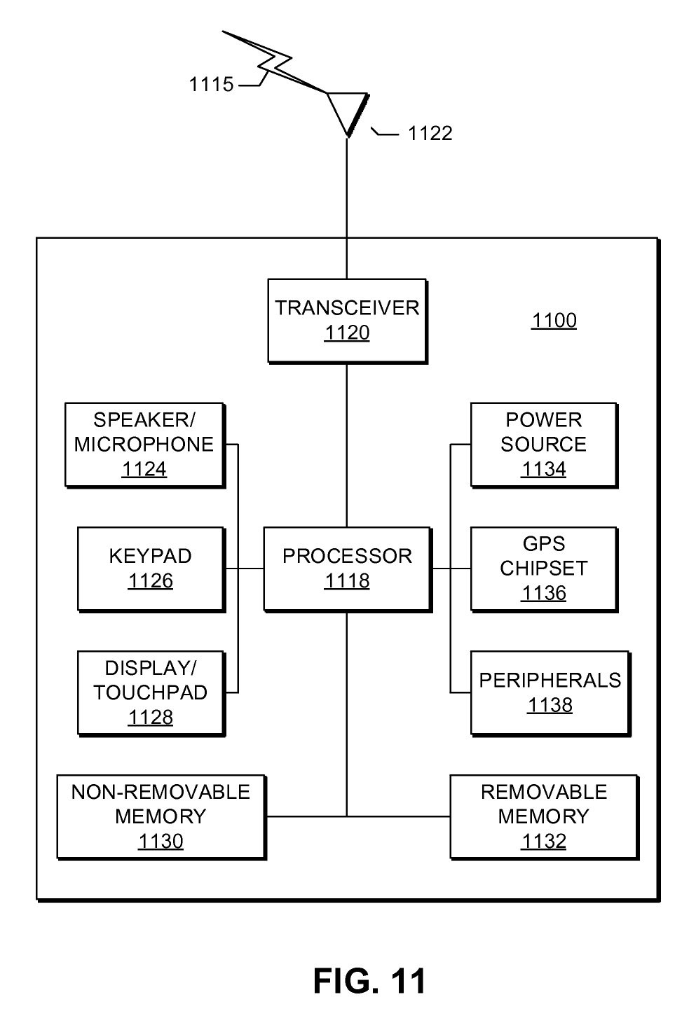

FIG. 11 is a system diagram of an example WTRU. As shown the example WTRU 1100 may include a processor 1118, a transceiver 1120, a transmit/receive element 1122, a speaker/microphone 1124, a keypad or keyboard 1126, a display/touchpad 1128, non-removable memory 1130, removable memory 1132, a power source 1134, a global positioning system (GPS) chipset 1136, and/or other peripherals 1138. It will be appreciated that the WTRU 1100 may include any sub-combination of the foregoing elements while remaining consistent with an embodiment. Further, a terminal in which an encoder (e.g., encoder 100) and/or a decoder (e.g., decoder 200) is incorporated may include some or all of the elements depicted in and described herein with reference to the WTRU 1100 of FIG. 11.

The processor 1118 may be a general purpose processor, a special purpose processor, a conventional processor, a digital signal processor (DSP), a graphics processing unit (GPU), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1118 may perform signal coding, data processing, power control, input/output processing, and/or any other functionality that enables the WTRU 1100 to operate in a wired and/or wireless environment. The processor 1118 may be coupled to the transceiver 1120, which may be coupled to the transmit/receive element 1122. While FIG. 11 depicts the processor 1118 and the transceiver 1120 as separate components, it will be appreciated that the processor 1118 and the transceiver 1120 may be integrated together in an electronic package and/or chip.

The transmit/receive element 1122 may be configured to transmit signals to, and/or receive signals from, another terminal over an air interface 1115. For example, in one or more embodiments, the transmit/receive element 1122 may be an antenna configured to transmit and/or receive RF signals. In one or more embodiments, the transmit/receive element 1122 may be an emitter/detector configured to transmit and/or receive IR, UV, or visible light signals, for example. In one or more embodiments, the transmit/receive element 1122 may be configured to transmit and/or receive both RF and light signals. It will be appreciated that the transmit/receive element 1122 may be configured to transmit and/or receive any combination of wireless signals.

In addition, although the transmit/receive element 1122 is depicted in FIG. 11 as a single element, the WTRU 1100 may include any number of transmit/receive elements 1122. More specifically, the WTRU 1100 may employ MIMO technology. Thus, in one embodiment, the WTRU 1100 may include two or more transmit/receive elements 11522 (e.g., multiple antennas) for transmitting and receiving wireless signals over the air interface 1115.

The transceiver 1120 may be configured to modulate the signals that are to be transmitted by the transmit/receive element 1122 and/or to demodulate the signals that are received by the transmit/receive element 1122. As noted above, the WTRU 1100 may have multi-mode capabilities. Thus, the transceiver 1120 may include multiple transceivers for enabling the WTRU 1100 to communicate via multiple RATs, such as UTRA and IEEE 802.11, for example.

The processor 1118 of the WTRU 1100 may be coupled to, and may receive user input data from, the speaker/microphone 1124, the keypad 1126, and/or the display/touchpad 1128 (e.g., a liquid crystal display (LCD) display unit or organic light-emitting diode (OLED) display unit). The processor 1118 may also output user data to the speaker/microphone 1124, the keypad 1126, and/or the display/touchpad 1128. In addition, the processor 1118 may access information from, and store data in, any type of suitable memory, such as the non-removable memory 1130 and/or the removable memory 1132. The non-removable memory 1130 may include random-access memory (RAM), read-only memory (ROM), a hard disk, or any other type of memory storage device. The removable memory 1132 may include a subscriber identity module (SIM) card, a memory stick, a secure digital (SD) memory card, and the like. In one or more embodiments, the processor 1118 may access information from, and store data in, memory that is not physically located on the WTRU 1100, such as on a server or a home computer (not shown).

The processor 1118 may receive power from the power source 1134, and may be configured to distribute and/or control the power to the other components in the WTRU 1100. The power source 1134 may be any suitable device for powering the WTRU 1100. For example, the power source 1134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 1118 may be coupled to the GPS chipset 1136, which may be configured to provide location information (e.g., longitude and latitude) regarding the current location of the WTRU 1100. In addition to, or in lieu of, the information from the GPS chipset 1136, the WTRU 1100 may receive location information over the air interface 1115 from a terminal (e.g., a base station) and/or determine its location based on the timing of the signals being received from two or more nearby base stations. It will be appreciated that the WTRU 1100 may acquire location information by way of any suitable location-determination method while remaining consistent with an embodiment.

The processor 1118 may further be coupled to other peripherals 1138, which may include one or more software and/or hardware modules that provide additional features, functionality and/or wired or wireless connectivity. For example, the peripherals 1138 may include an accelerometer, orientation sensors, motion sensors, a proximity sensor, an e-compass, a satellite transceiver, a digital camera and/or video recorder (e.g., for photographs and/or video), a universal serial bus (USB) port, a vibration device, a television transceiver, a hands free headset, a Bluetooth® module, a frequency modulated (FM) radio unit, and software modules such as a digital music player, a media player, a video game player module, an Internet browser, and the like.

By way of example, the WTRU 1100 may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a tablet computer, a personal computer, a wireless sensor, consumer electronics, or any other terminal capable of receiving and processing compressed video communications.

The WTRU 1100 and/or a communication network (e.g., communication network 1004) may implement a radio technology such as Universal Mobile Telecommunications System (UMTS) Terrestrial Radio Access (UTRA), which may establish the air interface 1115 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA). The WTRU 1100 and/or a communication network (e.g., communication network 1004) may implement a radio technology such as Evolved UMTS Terrestrial Radio Access (E-UTRA), which may establish the air interface 1115 using Long Term Evolution (LTE) and/or LTE-Advanced (LTE-A).

The WTRU 1100 and/or a communication network (e.g., communication network 1004) may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like. The WTRU 1100 and/or a communication network (e.g., communication network 1004) may implement a radio technology such as IEEE 802.11, IEEE 802.15, or the like.

### II. Temporal Block Vector Prediction.

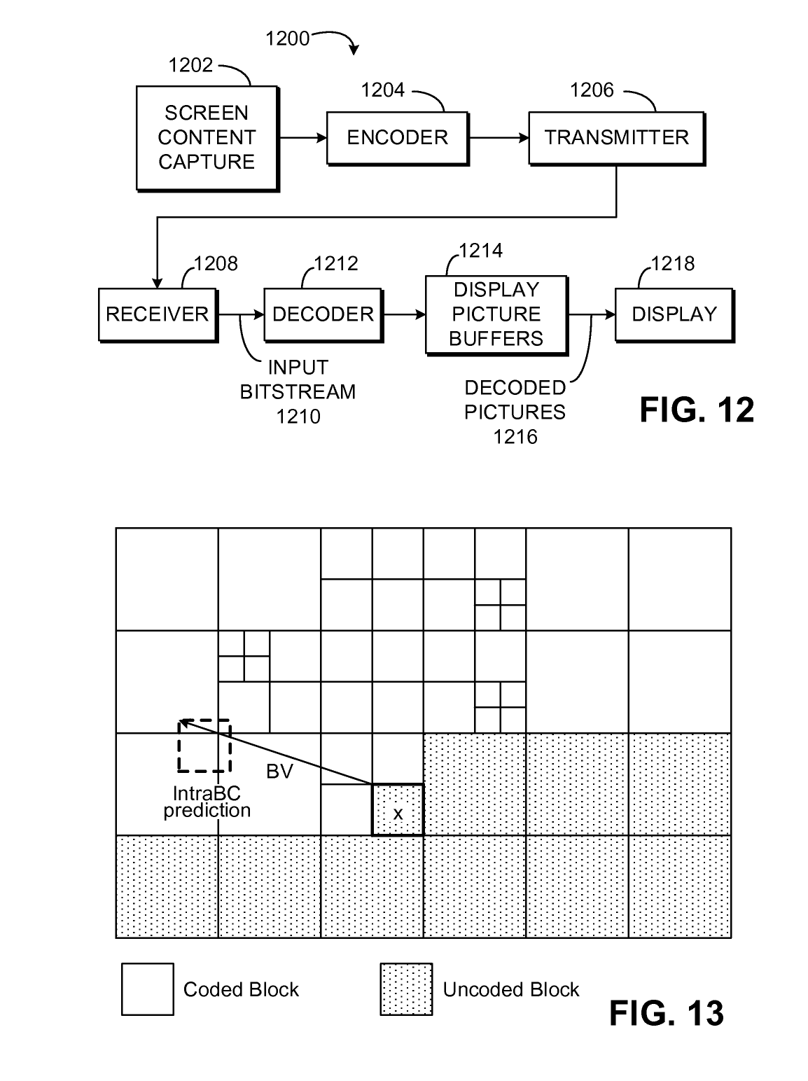

FIG. 12 is a functional block diagram illustrating an example two-way screen-content-sharing system 1200. The diagram illustrates a host sub-system including capturer 1202, encoder 1204, and transmitter 1206. FIG. 12 further illustrates a client sub-system including receiver 1208 (which outputs a received input bitstream 1210), decoder 1212, and display (renderer) 1218. The decoder 1212 outputs to display picture buffers 1214, which in turn transmits decoded pictures 1216 to the display 1218. As described in, for example, T. Vermeir, “Use cases and requirements for lossless and screen content coding”, JCTVC-M0172, April 2013, Incheon, KR, and in J. Sole, R. Joshi, M. Karczewicz, “AhG8: Requirements for wireless display applications”, JCTVC-M0315, April 2013, Incheon, KR, there are industry application requirements for screen content coding (SCC).

In order to save transmission bandwidth and storage, MPEG has been working on video coding standards for many years. High Efficiency Video Coding (HEVC), as described in B. Bross, W-J. Han, G. J. Sullivan, J-R. Ohm, T. Wiegand, “High Efficiency Video Coding (HEVC) Text Specification Draft 10”, JCTVC-L1003. January 2013, is the emerging video compression standard. HEVC is currently being jointly developed by ITU-T Video Coding Experts Group (VCEG) and ISO/IEC Moving Picture Experts Group (MPEG) together. HEVC can save 50% bandwidth compared to H.264 with the same quality. HEVC is still a block based hybrid video coding standard, in that its encoder and decoder generally operate according to FIGS. 1 and 2.

HEVC allows the use of larger video blocks, and uses quadtree partition to signal block coding information. The picture or slice is first partitioned into coding tree blocks (CTB) with the same size (e.g., 64×64). Each CTB is partitioned into coding units (CUs) with quadtree, and each CU is partitioned further into prediction units (PU) and transform units (TU), also using quadtree. For each inter coded CU, its PU can be one of 8 partition modes, as shown in FIG. 13. Temporal prediction, also called motion compensation, is applied to reconstruct all inter coded PUs. Depending on the precision of the motion vectors (which can be up to quarter pixel in HEVC), linear filters are applied to obtain pixel values at fractional positions. In HEVC, the interpolation filters have 7 or 8 taps for luma and 4 taps for chroma. The deblocking filter in HEVC is content based; different deblocking filter operations are applied at the TU and PU boundaries, depending on a number of factors, such as coding mode difference, motion difference, reference picture difference, pixel value difference, and so on. For entropy coding, HEVC adopts context-based adaptive arithmetic binary coding (CABAC) for most block level syntax elements except high level parameters. There are two kinds of bins in CABAC coding: one is context-based coded regular bins, and the other is by-pass coded bins without context.

Although the current HEVC design contains various block coding modes, it does not fully utilize the spatial redundancy for screen content coding. This is because HEVC is focused on continuous tone video content, and the mode decision and transform coding tools are not optimized for the discrete tone screen content which is often captured in the format of 4:4:4 video. After the HEVC standard was finalized in 2013, the standardization bodies VCEG and MPEG started to work on the future extension of HEVC for screen content coding (SCC). In January 2014, the Call for Proposals of screen content coding was jointly issued by ITU-T VCEG and ISO/IEC MPEG. See ITU-T Q6/16 and ISO/IEC JCT1/SC29/WG11, “Joint Call for Proposals for Coding of Screen Content”, MPEG2014/N14175, January 2014, San Jose, USA (“N14175 2014”). The CfP received 7 responses from different companies providing various efficient SCC solutions. Screen content such as text and graphics has highly repetitive patterns in term of line segments or blocks and has a lot of homogeneous small regions (e.g. mono-color regions). Usually only a few colors exist within a small block. In contrast, there are many colors even in a small block for natural video. The color value at each position is usually repeated from its above or left pixel. Given the different characteristics of screen content compared to natural video content, some novel coding tools that improve the coding efficiency of screen content coding were proposed. Examples include
1D string copy: T. Lin, S. Wang, P. Zhang, and K. Zhou, “AHG8: P2M based dual-coder extension of HEVC”, Document no JCTVC-L0303, January 2013.
Palette coding: X. Guo, B. Li, J.-Z. Xu, Y. Lu, S. Li, and F. Wu, “AHG8: Major-color-based screen content coding”, Document no JCTVC-00182, October 2013; L. Guo, M. Karczewicz, J. Sole, and R. Joshi, “Evaluation of Palette Mode Coding on HM-12.0+RExt-4.1”, JCTVC-00218, October 2013.
Intra block copy (IntraBC): C. Pang, J. Sole, L. Guo, M. Karczewicz, and R. Joshi, “Non-RCE3: Intra Motion Compensation with 2-D MVs”, JCTVC-N0256, July 2013; D. Flynn, M. Naccari, K. Sharman, C. Rosewarne, J. Sole, G. J. Sullivan, T. Suzuki, “HEVC Range Extension Draft 6”, JCTVC-P1005, January 2014, San Jose.

All those screen content coding related tools have been investigated in experiments:
J. Sole, S. Liu, “HEVC Screen Content Coding Core Experiment 1 (SCCE1): Intra Block Copying Extensions”, JCTVC-Q1121, March 2014, Valencia.
C.-C. Chen, X. Xu, L. Zhang, “HEVC Screen Content Coding Core Experiment 2 (SCCE2): Line-based Intra Copy”, JCTVC-Q1122, March 2014, Valencia.
Y.-W. Huang, P. Onno, R. Joshi, R. Cohen, X. Xiu, Z. Ma, “HEVC Screen Content Coding Core Experiment 3 (SCCE3): Palette mode”, JCTVC-Q1123, March 2014, Valencia.
Y. Chen, J. Xu, “HEVC Screen Content Coding Core Experiment 4 (SCCE4): String matching for sample coding”, JCTVC-Q1124, March 2014, Valencia.
X. Xiu, J. Chen, “HEVC Screen Content Coding Core Experiment 5 (SCCE5): Inter-component prediction and adaptive color transforms”, JCTVC-Q1125, March 2014, Valencia.

1D string copy predicts the string with variable length from previous reconstructed pixel buffers. The position and string length will be signaled. In palette coding, instead of directly coding the pixel value, a palette table is used as a dictionary to record those significant colors. And the corresponding palette index map is used to represent the color value of each pixel within the coding block. Furthermore, the “run” values are used to indicate the length of consecutive pixels which have the same significant colors (i.e., palette index) to reduce the spatial redundancy. Palette coding is usually selected for big blocks containing sparse colors. Intra block copy uses the already reconstructed pixels in the current picture to predict the current coding block within the same picture, and the displacement information called the block vector (BV) is coded.

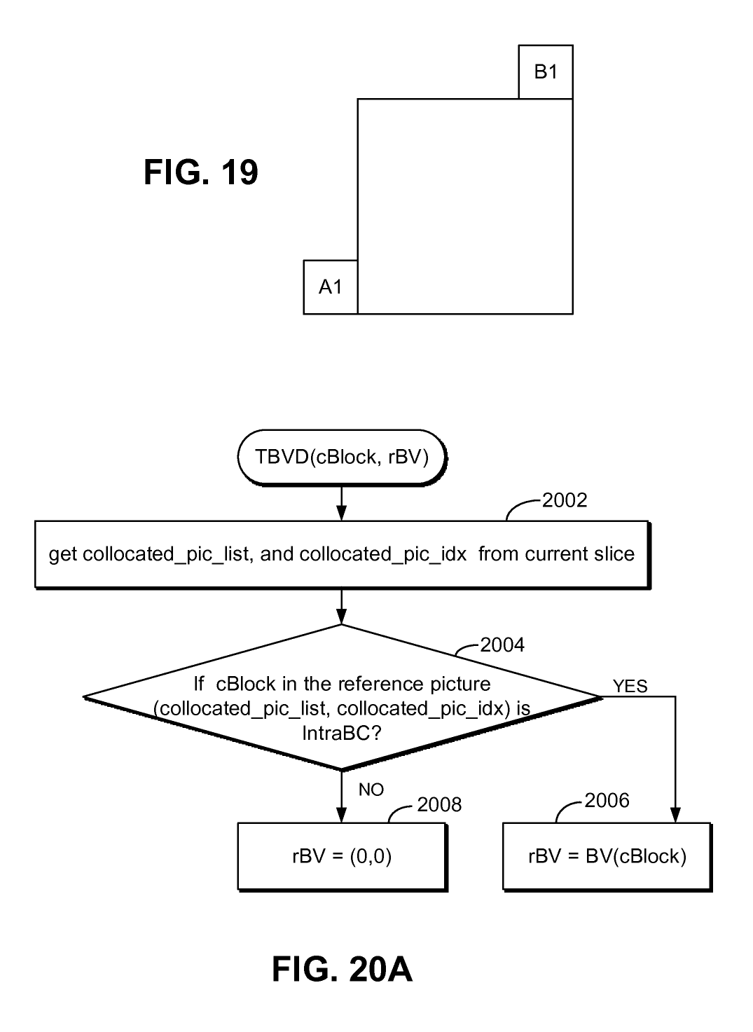

FIG. 19 shows an example of intra block copy. Considering the complexity and bandwidth access requirements, the HEVC SCC reference software (SCM-1.0) has two configurations for intra block copy mode. See R. Joshi, J. Xu, R. Cohen, S. Liu, Z. Ma, Y. Ye, “Screen content coding test model 1 (SCM 1)”, JCTVC-Q1014, March 2014, Valencia.

The first configuration is full-frame intra block copy, in which all reconstructed pixels can be used for prediction as shown in FIG. 13. In order to reduce the block vector search complexity, hash based intra block copy search has been proposed. See B. Li, J. Xu, “Hash-based intraBC search”, JCTVC-Q0252, March 2014, Valencia; C. Pang, J. Sole, T. Hsieh, M. Karczewicz, “Intra block copy with larger search region”, JCTVC-Q0139, March 2014, Valencia.

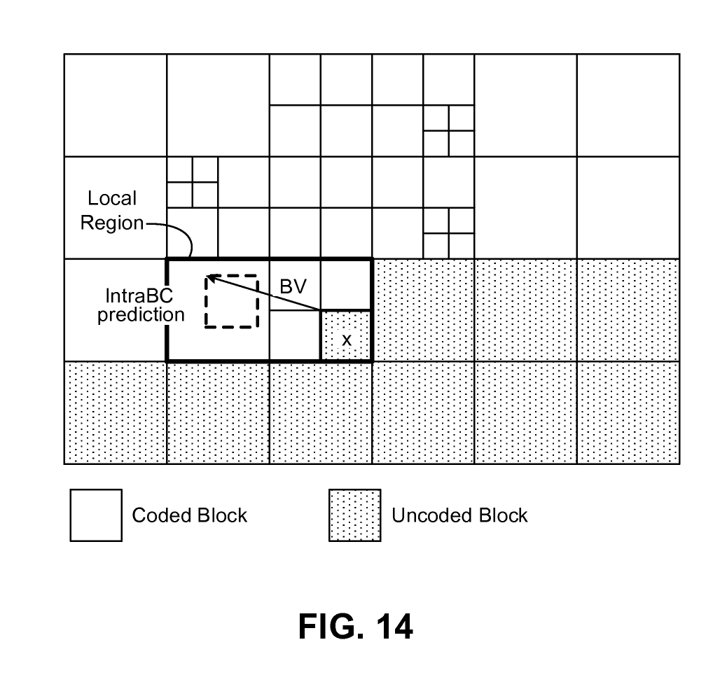

The second configuration is local region intra block copy as shown in FIG. 14, where only those reconstructed pixels in the left and the current coding tree units (CTU) are allowed to be used as reference.

There is another difference between SCC and natural video coding. For natural video coding, the coding distortion is usually distributed over in the whole picture. However, for screen content, the coding distortion or error is usually concentrated around strong edges. This error concentration can make the artifacts more visible even when the PSNR (peak signal to noise ratio) is quite high for whole picture. Therefore screen content is more difficult to encode from subjective quality point of view.

In the current HEVC standard, inter PU with merge mode can reuse the motion information from spatial and temporal neighboring prediction units to reduce the bits used for motion vector (MV) coding. If an inter coded 2N×2N CU uses merge mode and all quantized coefficients in all its transform units are zeros, then it is coded as skip mode to save bits further by skipping the coding of partition size, coded block flags at the root of TUs. The set of possible candidates in the merge mode are composed of multiple spatial neighboring candidates, one temporal neighboring candidate, and one or more generated candidates. HEVC allows up to 5 merge candidates.

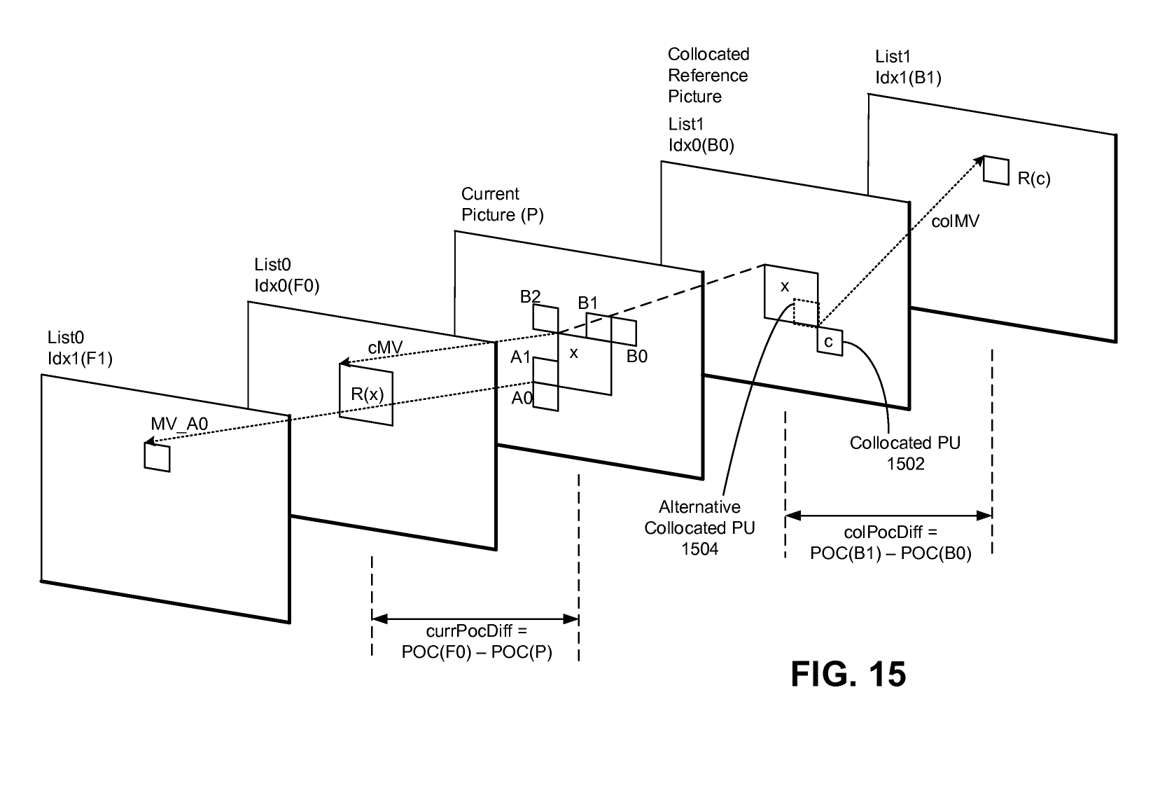

FIG. 15 shows the positions of the five spatial candidates. To construct the list of merge candidates, the five spatial candidates are firstly checked and added into the list according to the order A1, B1, B0, A0 and B2. If a block located at one spatial position is intra-coded or outside the boundary of the current slice, its motion is considered as unavailable and it will not be added to the candidate list. Furthermore, to remove the redundancy of the spatial candidates, any redundant entries where candidates have exactly the same motion information are also excluded from the list. After inserting all the valid spatial candidates into the merge candidate list, the temporal candidate is generated from the motion information of the co-located block in the co-located reference picture by temporal motion vector prediction (TMVP) technique. HEVC allows explicit signaling of the co-located reference picture used for TMVP in the bit stream (in the slice header) by sending its reference picture list and its reference picture index in the list. The actual number of merge candidates N (N=5 by default) is signaled in the slice header. If the number of merge candidates (including spatial and temporal candidates) is larger than N, then only the first N−1 spatial candidate and the temporal candidate are kept in the list. Otherwise, if the number of merge candidates is smaller than N, several combined candidates and zero motion candidates could be added to the candidate list until the number reaches N. See B. Bross, W-J. Han, G. J. Sullivan, J-R. Ohm, T. Wiegand, “High Efficiency Video Coding (HEVC) Text Specification Draft 10”, JCTVC-L1003. January 2013.

Taking FIG. 15 as an example, the checking order to construct the inter merge candidate list is summarized as follows,
(Merge-Step 1) Check the left neighboring PU A1. If A1 is an inter PU, then add its MV to the candidate list.
(Merge-Step 2) Check the top neighboring PU B 1. If B1 is an inter PU and its MV is unique in the list, then add its MV to the candidate list.
(Merge-Step 3) Check the top right neighboring PU B0. If B0 is an inter PU and its MV is different from the MV of B1 if B1 is an inter PU, then add its MV to the candidate list.
(Merge-Step 4) Check the bottom left neighboring PU A0. If A0 is an inter PU and its MV is different from the MV of A1 if A1 is inter PU, then add its MV to the candidate list.
(Merge-Step 5) If the number of candidates is smaller than 4, then check the top left neighboring PU B2. If B2 is an inter PU and its MV is different from the MV of B1 if B1 is an inter PU and different from the MV of A1 if A1 is an inter PU, then add its MV to the candidate list.
(Merge-Step 6) Check the collocated PU C in the collocated picture with the TMVP method described below.
(Merge-Step 7) If the inter merge candidate list is not full, and if the current slice is a B slice, then combinations of various merge candidates which were added to the current merge list during steps (Merge-Step 1) through (Merge-Step 6) are checked and added to the merge candidate list.
(Merge-Step 8) If the inter merge candidate list is not full, then zero motion vector with different reference picture combinations starting from the first reference picture in the reference picture list are appended to the list in order until the list is full.

If the coded slice is a B slice, the process “Merge-Step 8” adds those bi-prediction candidates with zero motion vector by traversing all reference picture indices shared by both lists (e.g. list-0 and list-1). In an embodiment, a MV can be expressed as a four-component variable (list_idx, ref_idx, MV_x, MV_y). The value list_idx is the list index and can be either 0 (e.g. list-0) or 1 (e.g. list-1); ref_idx is the reference picture index in the list specified by list_idx; and MV_x and MV_y are two components of the motion vector in horizontal and vertical directions. The “Merge-Step 8” process then derives the number of shared indices in both lists using the following equation:

numRefIdx=Min(num_ref_idx_{—1}0,num_ref_idx_{—1}1),

where num_ref_idx_{—1}0 and num_ref_idx_{—1}1 are the number of reference pictures in list-0 and list-1, respectively. Then the MV pair for the merge candidate with bi-prediction mode is added in order until the merge candidate list is full:

{(0,ref_idx(i),0,0),(1,ref_idx(i),0,0)},i≧0

where ref_idx(i) is defined as:

$$ref\_idx ( i ) = \{ \begin{matrix}i , & if i < numRefIdx \\ 0 , & otherwise\end{matrix}$$

For non-merge mode, HEVC allows the current PU to select its MV predictor from spatial and temporal candidates. This is referred to herein as AMVP or advanced motion vector prediction. For AMVP, only two spatial motion predictor candidates at maximum could be selected among the five spatial candidates in FIG. 15, according to their availability. The first spatial candidate is chosen from the set of left positions A1 and A0, and the second spatial candidate is chosen from the set of top positions B1, B0 and B2, while searching is conducted in the same order as indicated in two sets. Only available and unique spatial candidates are added to the predictor candidate list. When the number of available and unique spatial candidates is less than 2, the temporal MV predictor candidate generated from the TMVP process is then added to the list. Finally, if the list still contains less than 2 candidates, zero MV predictor could be also added repeatedly until the number of MV predictor candidates is equal to 2.

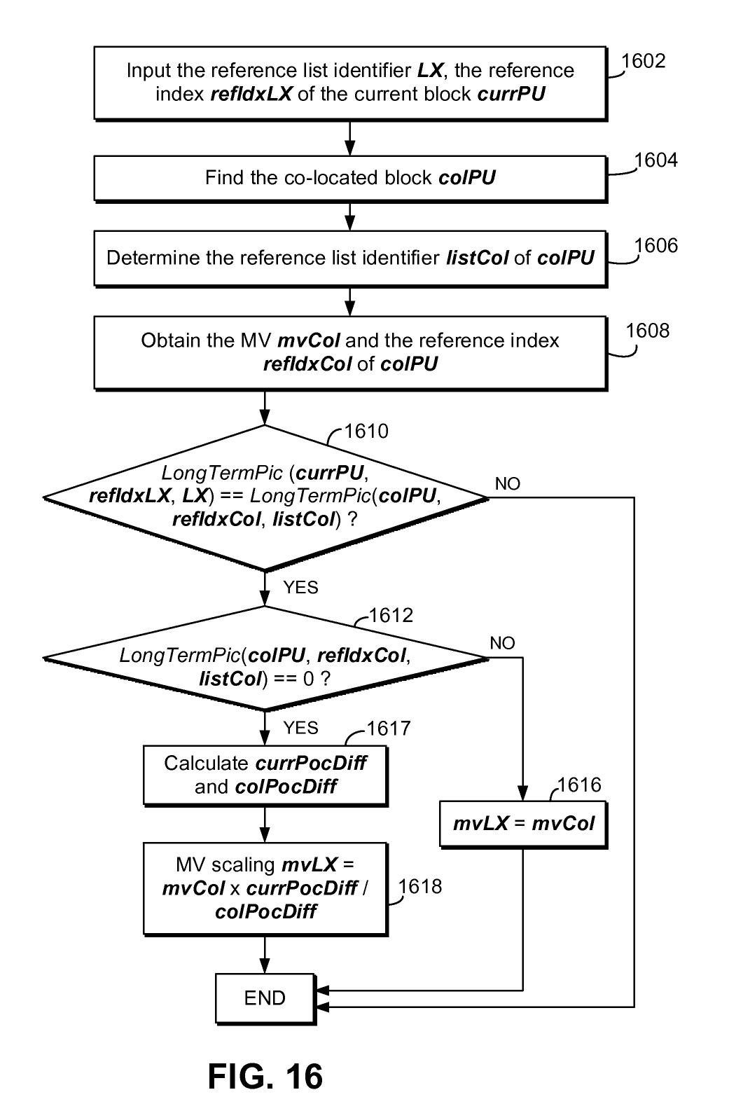

FIG. 16 is a flow chart of the TMVP process used in HEVC to generate the temporal candidate, denoted as mvLX, for both merge mode and non-merge mode. The input reference list LX and reference index refIdxLX (X being 0 or 1) of the current PU currPU are input in step 1602. In step 1604, the co-located block colPU is identified by checking the availability of the right-bottom block just outside the region of currPU in the co-located reference picture. This is shown in FIG. 15 as “collocated PU” 1502. If the right-bottom block is unavailable, the block at the center position of currPU in the co-located reference picture is used instead, shown in FIG. 15 as “alternative collocated PU” 1504. Then, the reference list listCol of colPU is determined in step 1606 based on the picture order count (POC) of the reference pictures of the current picture and the reference list of the current picture used to locate the co-located reference picture, as will be explained in the next paragraph. The reference list listCol is then used in step 1608 to retrieve the corresponding MV mvCol and reference index refIdxCol of colPU. In steps 1610-1612, the long/short term characteristic of the reference picture of currPU (indicated by refIdxLX) is compared to that of the reference picture of colPU(indicated by refIdxCol). If one of the two reference pictures is a long term picture while the other is a short term picture, then the temporal candidate mvLX is considered as unavailable. Otherwise, if both of the two reference pictures are long term pictures, then mvLX is directly set equal to be mvCol in step 1616. Otherwise (both of the two reference pictures are short term pictures), mvLX is set to be a scaled version of mvCol in steps 1617-1618.

In FIG. 16, currPocDiff is used to denote the POC difference between the current picture and the reference picture of currPU, and colPocDiff denotes the POC difference between the co-located reference picture and the reference picture of colPU. These two POC difference values are also illustrated in FIG. 15. Given both currPocDiff and colPocDiff, the predicted MV mvLX of currPU is calculated from mvCol as given by

$$mvLX = mvCol \times \frac{currPocDiff}{colPocDiff} \qquad ( 4 )$$

Moreover, in the merge mode of HEVC standard, the reference index for the temporal candidate is always set equal to 0, i.e., refIdxLX is always equal to 0, meaning the temporal merge candidate always comes from the first reference picture in list LX.

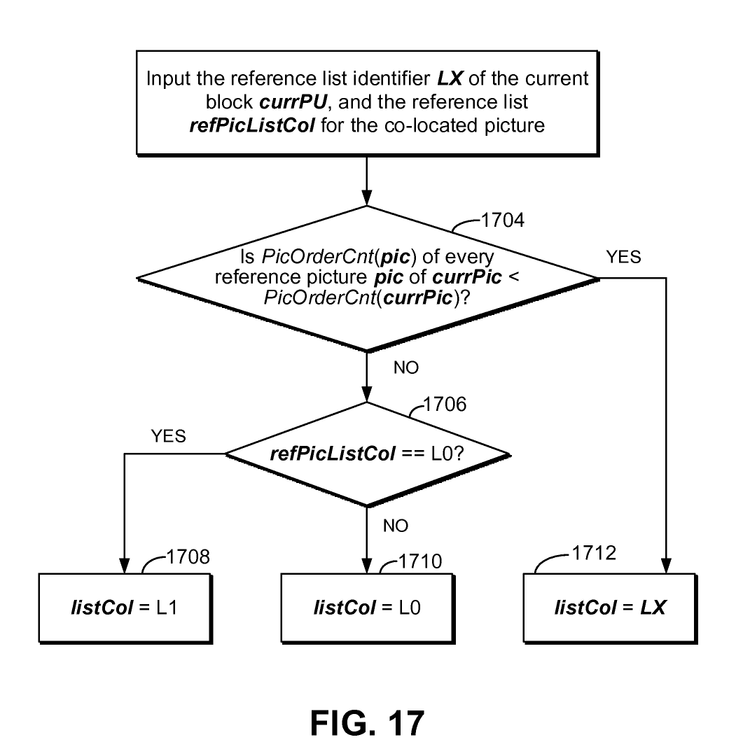

The reference list listCol of colPU is chosen based on the POCs of the reference pictures of the current picture currPic as well as the reference list refPicListCol of currPic containing the co-located reference picture; refPicListCol is signaled in the slice header using syntax element collocated_from_l0_flag. FIG. 17 shows the process of selecting listCol in HEVC. See B. Bross, W-J. Han, G. J. Sullivan, J-R. Ohm, T. Wiegand, “High Efficiency Video Coding (HEVC) Text Specification Draft 10”, JCTVC-L1003, January 2013. If, in step 1704, the POC of every picture pic in the reference picture lists of currPic is less than or equal to the POC of currPic, listCol is set equal to the input reference list LX (X being 0 or 1) in step 1712. Otherwise (if at least one reference picture pic in at least one reference picture list of currPic has POC greater than the POC of currPic), listCol is set equal to the opposite of refPicListCol in steps 1706, 1708, 1710.

Given the list cList(cMV) and reference picture index cIdx(cMV) of the motion vector cMV for current PU, the MV predictor list construction process is summarized as follows,
(1) Check the bottom left neighboring PU A0. If A0 is an inter PU and the MV of A0 in the list cList(cMV) refers to the same reference picture as cMV, then add it to the predictor list; otherwise, check the MV of A0 at another list oppositeList(cList(cMV)). If this MV refers to the same reference picture as cMV, then add it in the list, otherwise A0 fails. The function oppositeList(ListX) defines the opposite list of ListX, where:

oppositeList(ListX)=(ListX==List0?List1:List0)
(2) If A0 fails, then check A1 in the same way as (1).
(3) If both steps (1) and (2) fail, if A0 is an inter PU and its motion vector MV_A0 in the list cList(cMV) is short term MV, and cMV is also a short term motion vector, then scale MV_A0 according to POC distance:

MV_Scaled=MV_A0*(POC(F0)−POC(P))/(POC(F1)−POC(P))
Add scaled motion vector MV_Scaled to the list. If MV_A0 and cMV are both long-term MVs, then add MV_A0 to the list without scaling; otherwise check the motion vector in the opposite list oppositeList(cList(cMV)) of A0 in the same way.
(4) If step (3) fails, then check A1 as described in step (3); otherwise go to step (5).
(5) So far, at most there is one MV predictor coming from A0 or A1. If both A0 and A1 are not inter PUs, check B0 and B1 in the same way described in (1)(2)(3)(4) in order of (B0, B1) to find another MV predictor; otherwise, check B0 and B1 in the same way described in (1)(2).
(6) Remove the repeated MV predictors from the list, if any.
(7) If the list is not full, then use the mvLX generated by TMVP described above to fill the list.
(8) Fill the zero motion vectors in the list until the list is full.

In the SCM draft specification, the IntraBC is signaled as an additional CU coding mode (Intra Block Copy mode), and it is processed as intra mode for decoding and deblocking. See R. Joshi, J. Xu, “HEVC Screen Content Coding Draft Text 1”, JCTVC-R1005, July 2014, Sapporo, JP; R. Joshi, J. Xu, “HEVC Screen Content Coding Draft Text 2”, JCTVC-S1005, October 2014, Strasbourg, FR (“Joshi 2014”). There are no IntraBC merge mode and IntraBC skip mode. To improve the coding efficiency, it has been proposed to combine the intra block copy mode with inter mode. See B. Li, J. Xu, “Non-SCCE1: Unification of intra BC and inter modes”, JCTVC-R0100, July 2014, Sapporo, JP (hereinafter “Li 2014”); X. Xu, S. Liu, S. Lei, “SCCE1 Test2.1: IntraBC coded as Inter PU”, JCTVC-R0190, July 2014, Sapporo, JP (hereinafter “Xu 2014”).

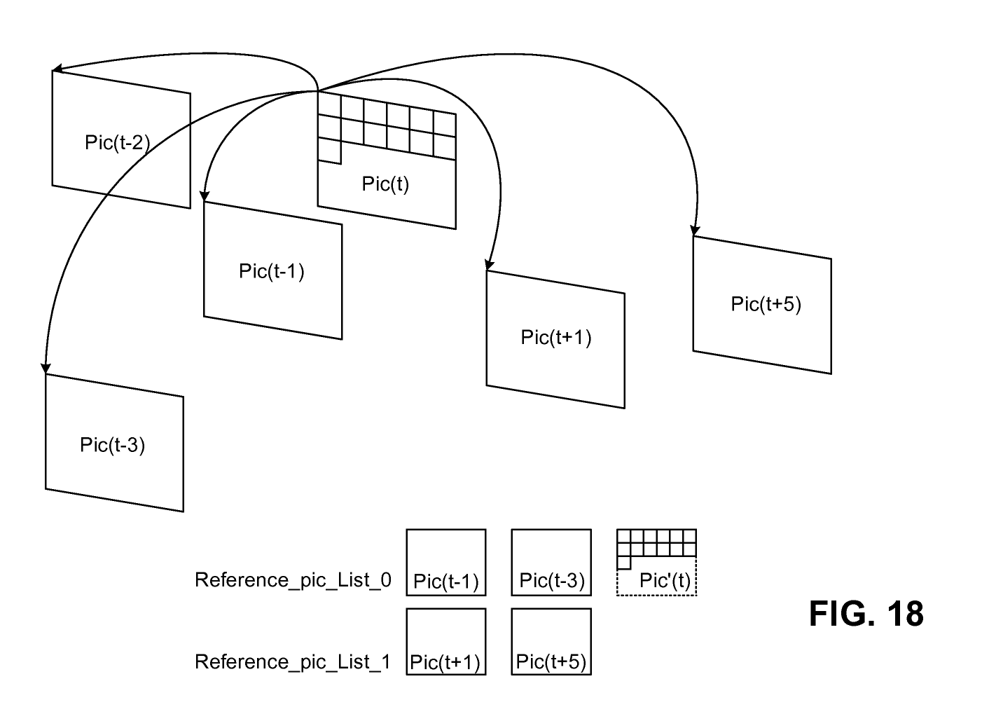

FIG. 18 illustrates a method using a hierarchical coding structure. The current picture is denoted as Pic(t). The already decoded portion of the current picture before deblocking and SAO are applied is denoted as Pic′(t). In normal temporal prediction, the reference picture list_0 consists of temporal reference pictures Pic(t−1) and Pic(t−3) in order, and the reference picture list_1 consists of Pic(t+1) and Pic(t+5) in order. Pic′(t) is additionally placed at the end of one reference list (list_0) and marked as a long term picture and used as a “pseudo reference picture” for intra block copy mode. This pseudo reference picture Pic′(t) is used for IntraBC copy prediction only, and will not be used for motion compensation. Block vectors and motion vectors are stored in list_0 motion field for the respective reference pictures. The intra block copy mode is differentiated from inter mode using the reference index at the prediction unit level: for the IntraBC prediction unit, the reference picture is the last reference picture, that is, the reference picture with the largest ref_idx value, in list_0; and this last reference picture is marked as a long term reference picture. This special reference picture has the same picture order count (POC) as the POC of current picture; in contrast, the POC of any other regular temporal reference picture for inter prediction is different from the POC of the current picture.

In the methods in (Li 2014) and (Xu 2014), the IntraBC mode and inter mode share the same merge process, which is the same as the merge process originally specified in HEVC for inter merge mode, as explained above. Using these methods, the IntraBC PU and inter PU can be mixed within one CU, improving coding efficiency for SCC. In contrast, the current SCC test model uses CU level IntraBC signaling, and therefore does not allow a CU to contain both IntraBC PU and inter PU at the same time.

Another framework design for IntraBC is described in (Li 2014), (N14175 2014), and C. Pang, K. Rapaka, Y.-K. Wang, V. Seregin, M. Karczewicz, “Non-CE2: Intra block copy with Inter signaling”, JCTVC-S0113, October 2014 (hereinafter “Pang October 2014”). In this framework, the IntraBC mode is unified with inter mode signaling. Specifically, a pseudo reference picture is created to store the reconstructed portion of the current picture (picture currently being coded) before loop filtering (deblocking and SAO) is applied. This pseudo reference picture is then inserted into the reference picture lists of the current picture. When this pseudo reference picture is referred to by a PU (that is, when its reference index is equal to that of the pseudo reference picture), the intraBC mode is enabled by copying a block from the pseudo reference picture to form the prediction of the current prediction unit. As more CUs are coded in the current picture, the reconstructed sample values of these CUs before loop filtering are updated into the corresponding regions of the pseudo reference picture. The pseudo reference picture is treated almost the same as any regular temporal reference pictures, with the following differences:

1. The pseudo reference picture is marked as a “long term” reference picture, whereas in most typical cases, the temporal reference pictures are most likely to be “short term” reference pictures.

2. In default reference picture list construction, the pseudo reference picture is added to L0 if P slice and added to both L0 and L1 if B slice. The default L0 is constructed following the order of: reference pictures temporally before (in display order) the current picture in order of increasing POC differences, the pseudo reference picture representing the reconstructed portion of the current picture, reference pictures temporally after (in display order) the current picture in order of increasing POC differences. The default L1 is constructed following the order of: reference pictures temporally after (in display order) the current picture in order of increasing POC differences, the pseudo reference representing the reconstructed portion of the current picture, reference pictures temporally before (in display order) the current picture in order of increasing POC differences.

3. In the design of (Pang October 2014), the pseudo reference picture is prevented from being used as the collocated picture for temporal motion vector prediction (TMVP).

4. At any random access point (RAP), all temporal reference pictures will be cleared from the Decoded Picture Buffer (DPB). But the pseudo reference picture will still exist.

5. All block vectors that refer to the pseudo reference picture are forced to have only integer-pixel values, although they are stored in quarter pixel precision in (Pang October 2014) according to bitstream conformance requirements.

In an exemplary unified IntraBC and inter framework, a modified default zero MV derivation has been proposed by considering default block vectors. First, there are five default BVs denoted as dBVList and defined as:

{−CUw,0},{−2*CUw,0},{0,−CUh},{0,−2*CUh},{−CUw,−CUh},

where CUw and CUh are width and height of the CU. In “Merge-Step 8”, the MV pair for the merge candidate with bi-prediction mode is derived in the following way:

{(0,ref_idx(i),mv0_x,mv0_y),(1,ref_idx(i),mv1_x,mv1_y)},i≧0

where ref_idx(i) may be implemented as described above with respect to “Merge-Step 8.” If the reference picture with the index equal to ref_idx(i) in list-0 is the current picture, then mv0_x and mv0_y are set as one of the default BVs:

mv0_x=dBVList[dBVIdx][0]

mv0_y=dBVList[dBVIdx][1]

and dBVIdx is increased by 1. Otherwise, mv0_x and mv0_y are both set to zero. If the reference picture with index equal to ref_idx(i) in list-1 is the current picture, then mv1_x and mv1_y are set as one of the default BVs:

mv1_x=dBVList[dBVIdx][0]

mv1_y=dBVList[dBVIdx][1]

and dBVIdx is increased by 1. Otherwise, mv1_x and mv1_y are both set to zero.

In such embodiments, no special flag (intra_bc_flag) is signaled in the bitstream to indicate intraBC prediction; instead, intraBC is signaled in the same way as other inter coded PUs in a transparent manner. Additionally, in the design in (Pang October 2014), all I slices will become P or B slices, with one or two reference picture lists, each containing only the pseudo reference picture.

The intraBC designs in (Li 2014) and (Pang October 2014) improve the screen content coding efficiency compared to SCM-2.0 for the following reasons:

1. They allow the inter merge process to be applied in a transparent manner. Because all block vectors are treated like motion vectors (with their reference picture being the pseudo reference picture), the inter merge process discussed above can be directly applied.

2. Unlike (Li 2014) which stores the block vectors in integer-pel precision, the design in (Pang October 2014) stores the block vectors in quarter-pixel precision, the same as regular motion vectors. This allows deblocking filter parameters to be calculated correctly when at least one of the two neighboring blocks in deblocking uses intraBC prediction mode.

3. This new intraBC framework allows the intraBC prediction to be combined with either another IntraBC prediction or the regular motion compensated prediction using the bi-prediction method.

The spatial displacements are of full pixel precision for typical screen, content, such as text and graphics. In B. Li, J. Xu, G. Sullivan, Y. Zhou, B. Lin, “Adaptive motion vector resolution for screen content”, JCTVC-50085, October 2014, Strasbourg, FR, there is a proposal to add a signal indicating whether the resolution of motion vectors in one slice is of integer or fractional pixel (e.g. quarter pixel) precision. This can improve motion vector coding efficiency because the value used to represent integer motion may be smaller compared to the value used to represent quarter-pixel motion. The adaptive motion vector resolution method was adopted in a design of the HEVC SCC extension (Joshi 2014). Multi-pass encoding can be used to choose whether to use integer or quarter-pixel motion resolution for the current slice/picture, but the complexity will be significantly increased. Therefore, at the encoder side, the SCC reference encoder (Joshi 2014) decides the motion vector resolution with a hash-based integer motion search. For every non-overlapped 8×8 block in a picture, the encoder checks whether it can find a matching block using a hash-based search in the first reference picture in list_0. The encoder classifies non-overlapped blocks (e.g. 8×8) into four categories: perfectly matched block, hash matched block, smooth block, un-matched block. The block will be classified as a perfectly matched block if all pixels (three components) between current block and its collocated block in reference picture are exactly the same. Otherwise, the encoder will check if there is a reference block that has the same hash value as the hash value of current block via a hash-based search. The block will be classified as a hash-matched block if a hash value matched block is found. The block will be classified as smooth block if all pixels have the same value either in horizontal direction or in vertical direction. If the overall percentage of perfectly matched blocks, hash-matched blocks, and smooth blocks is greater than a first threshold (e.g. 0.8), and the average of the percentages of matched blocks and smooth blocks of a number of previously coded pictures (e.g. 32 previous pictures) is greater than a second threshold (e.g. 0.95), and the percentage of hash-matched blocks is greater than a third threshold, then integer motion resolution is selected, otherwise quarter pixel motion resolution is selected. Having integer motion resolution means there are a great number of perfectly matched or hash-matched blocks in the current picture. This indicates the motion compensated prediction is quite good. This information will be used in the proposed bi-prediction search discussed below in the section entitled “Bi-prediction search for bi-prediction mode with BV and MV.”

There are several drawbacks for the IntraBC and inter mode unification method proposed in (Li 2014) and (Xu 2014). Using existing merge process in the draft specification of SCC, R. Joshi, J. Xu, “HEVC Screen Content Coding Draft Text 1”, JCTVC-R1005, July 2014, Sapporo, JP, if the temporal collocated block colPU in the collocated reference picture is IntraBC coded, then its block vector will most likely not be used as a valid merge candidate in the merge mode for mainly two reasons.

First, block vectors use the special reference picture, which is marked as a long term reference picture. In contrast, most temporal motion vectors usually refer to regular temporal reference pictures that are short term reference pictures. Since block vectors (long term) are classified differently from regular motion vectors (short term), the existing merge process prevents using motion from a long term reference picture to predict motion from a short term reference picture.

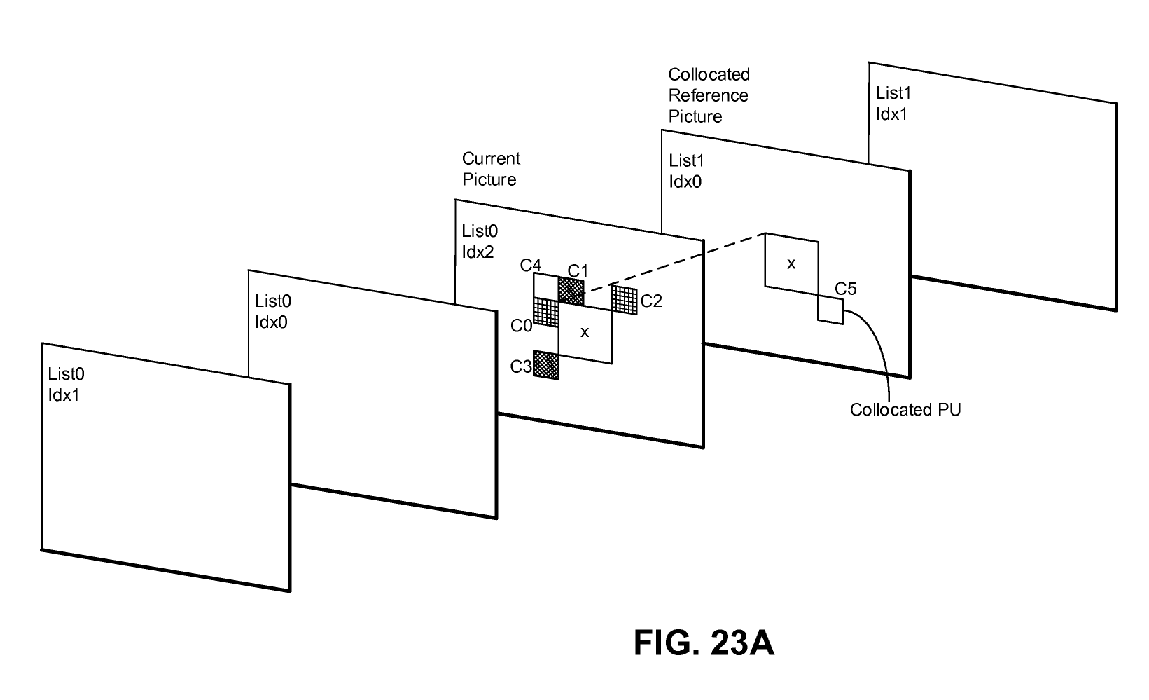

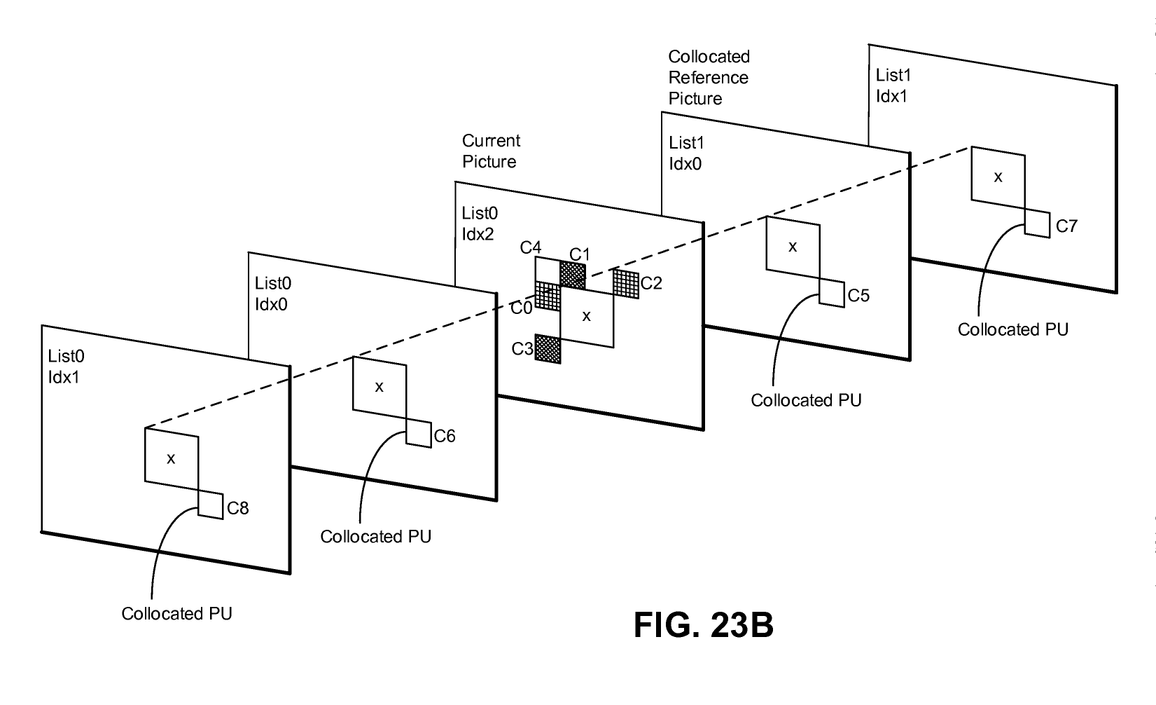

Second, the existing inter merge process only allows those MV/BV candidates with the same motion type as that of the first reference picture in the collocated list (list_0 or list_1). Because usually the first reference picture in list_0 or list_1 is a short term temporal reference picture, while block vectors are classified as long-term motion information, IntraBC block vectors cannot generally be used. Another drawback for this shared merging process is that it sometimes generates a list of mixed merge candidates, where some of the merge candidates may be block vectors and others may be motion vectors. FIGS. 23A-B show an example, where IntraBC and inter candidates will be mixed together. The spatial neighboring blocks C0 and C2 are IntraBC PUs with block vectors. Blocks C1 and C3 are inter PUs with motion vectors. PU C4 is an intra or palette block. Without loss of generality, assume that temporal collocated block C5 is an inter PU. The merge candidate list generated using the existing merge process is C0 (BV), C1 (MV), C2 (BV), C3 (MV) and C5 (MV). The list will only contain up to 5 candidates due to the limitation on the total number of merge candidates. In this case, if the current block is coded as an inter block, then only 3 inter candidates (C1, C3 and C5) will likely be used for inter merge, since the 2 candidates from C0 and C2 represent block vectors and do not provide meaningful prediction for motion vectors. This means 2 out of 5 merge candidates are actually “wasted”. The same problem (of wasting some entries on the merge candidate list) also exists if the current PU is an intraBC PU, since to predict the current PU's block vector, motion vectors from C1, C3 and C5 will not likely be useful.

A third problem exists for block vector prediction for non-merge mode. For the method proposed in (Li 2014) and (Xu 2014), the existing AMVP design is used for BV prediction. Because IntraBC applies uni-prediction only using one reference picture, when the current PU is coded with IntraBC, its block vector always comes from list_0 only. Therefore, only one list (list_0) at most is available for deriving the block vector predictor using the current AMVP design. In comparison, majority of the inter PUs in B slices are bi-predicted, with motion vectors coming from two lists (list_0 and list_1). Therefore, these regular motion vectors can use two lists (list_0 and list_1) to derive their motion vector predictors. Usually there are multiple reference pictures in each list (for example, in the random access and low delay setting in SCC common test conditions). By including more reference pictures from both lists when deriving block vector predictors, BV prediction can be improved.

For the framework for IntraBC provided in (Li 2014), (Pang October 2014), the inter merge process is applied without modifications. However, applying inter merge directly has the following problems that may reduce the coding efficiency.

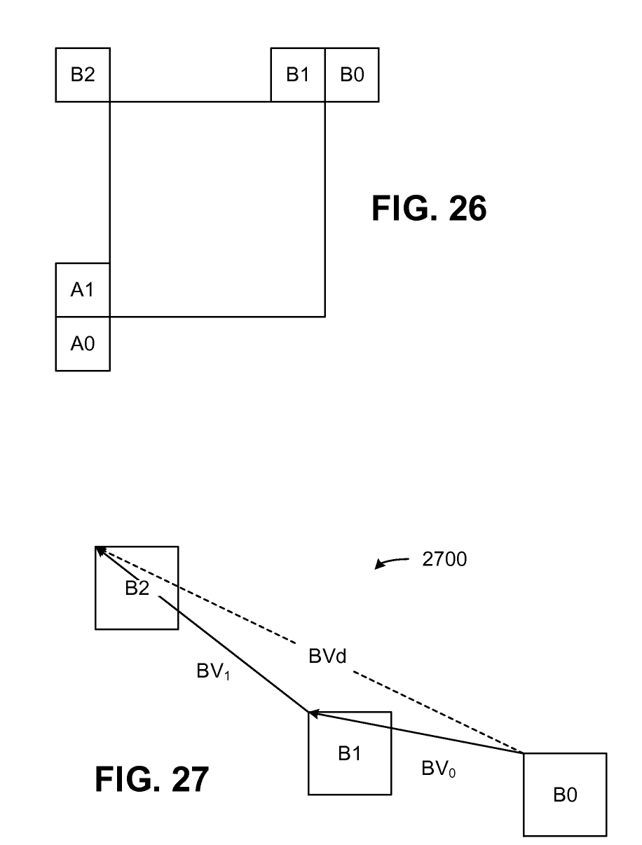

First, when forming the spatial merge candidates, neighboring blocks labeled as A0, A1, B0, B1, B2 in FIG. 26 are used. However, some of the block vectors of these spatial neighbors may not be valid block vector candidates for the current PU. This is because the pseudo reference picture contains only valid samples of CUs that have been coded and reconstructed, and some of the neighboring block vectors may require reference to a part of the pseudo reference picture that has not been reconstructed yet. With the current inter merge design, these invalid block vectors may still be inserted into the merge candidate list, leading to wasted (invalid) entries on the merge candidate list.

Second, the motion vectors in the HEVC codec are classified into short term MVs and long term MVs, depending on whether they point to a short term reference picture or a long term reference picture. In the normal TMVP process in the HEVC design, short term MVs can not be used to predict long term MVs, nor can long term MVs be used to predict short term MVs. For block vectors used in IntraBC prediction, because they point to the pseudo reference picture, which is marked as long term, they are considered long term MVs. Yet, when invoking the TMVP process for the existing merge process, the reference index of either L0 or L1 is always set to 0 (that is, the first entry on L0 or L1). As this first entry is usually given to a temporal reference picture, which is typically a short term reference picture, the current merge process prevents the block vectors from the collocated PUs to be considered as valid temporal merge candidates (due to long term vs short term mismatch). Therefore, when invoking the TMVP process “as is” during the merge process, if the collocated block in the collocated picture is IntraBC predicted and contains a BV, the merge process will consider this temporal predictor invalid, and will not add it as a valid merge candidate. In other words, TBVP will be disabled in the designs of (Li 2014), (Pang October 2014) for many typical configuration settings.

In this disclosure, various embodiments are described, some of which address one or more of the problems identified above and improve the coding efficiency of the unified IntraBC and inter framework.

Embodiments of the present disclosure combine intraBC mode with inter mode and also signal a flag (intra_bc_flag) at the PU level for both merge and non-merge mode, such that IntraBC merge and inter merge can be distinguished at the PU level.

Embodiments of the present disclosure can be used to optimize those two separated process respectively: inter merge process and IntraBC merge process. By separating the inter merge process and the IntraBC merge process from each other, it is possible to keep a greater number of meaningful candidates for both inter merge and IntraBC merge. In some embodiments, temporal BV prediction is used to improve BV coding. In some embodiments, temporal BV is used as one of the IntraBC merge candidates to further improve the IntraBC merge mode. Various embodiments of the present disclosure include (1) temporal block vector prediction (TBVP) for IntraBC BV prediction and/or (2) intra block copy merge mode with temporal block vector derivation.

### Temporal Block Vector Prediction (TBVP).

In current SCC design, there are at most 2 BV predictors. The list of BV predictors is selected from a list of spatial predictors, last predictors, and default predictors, as follows. An ordered list containing 6 BV candidate predictors is formed as follows. The list consists of 2 spatial predictors, 2 last predictors, and 2 default predictors. Note that not all of the 6 BVs are available or valid. For example, if a spatial neighboring PU is not IntraBC coded, then the corresponding spatial predictor is considered unavailable or invalid. If less than 2 PUs in the current CTU have been coded in IntraBC mode, then one or both of the last predictors may be unavailable or invalid. The ordered list is as follows: (1) Spatial predictor SPa. This is the first spatial predictor from bottom left neighboring PU A1, as shown in FIG. 19. (2) Spatial predictor SPb. This is the second spatial predictor from top right neighboring PU B1, as shown in FIG. 19. (3) Last predictor LPa. This is the predictor from the last IntraBC coded PU in the current CTU. (4) Last predictor LPb. This is the second last predictor from an earlier IntraBC coded PU in the current CTU. When available and valid, LPb is different from LPa (this is guaranteed by checking that a newly coded BV is different from the existing 2 last predictors and only adding it as a last predictor if so). (5) Default predictor DPa. This predictor is set to (−2*widthPU, 0), where widthPU is the width of current PU. (6) Default predictor DPb. This predictor is set to (−widthPU, 0), where widthPU is the width of current PU. The ordered candidate list from step 1 is scanned from the first candidate predictor to the last candidate predictor. Valid and unique BV predictors are added to the final list of at most 2 BV predictors.

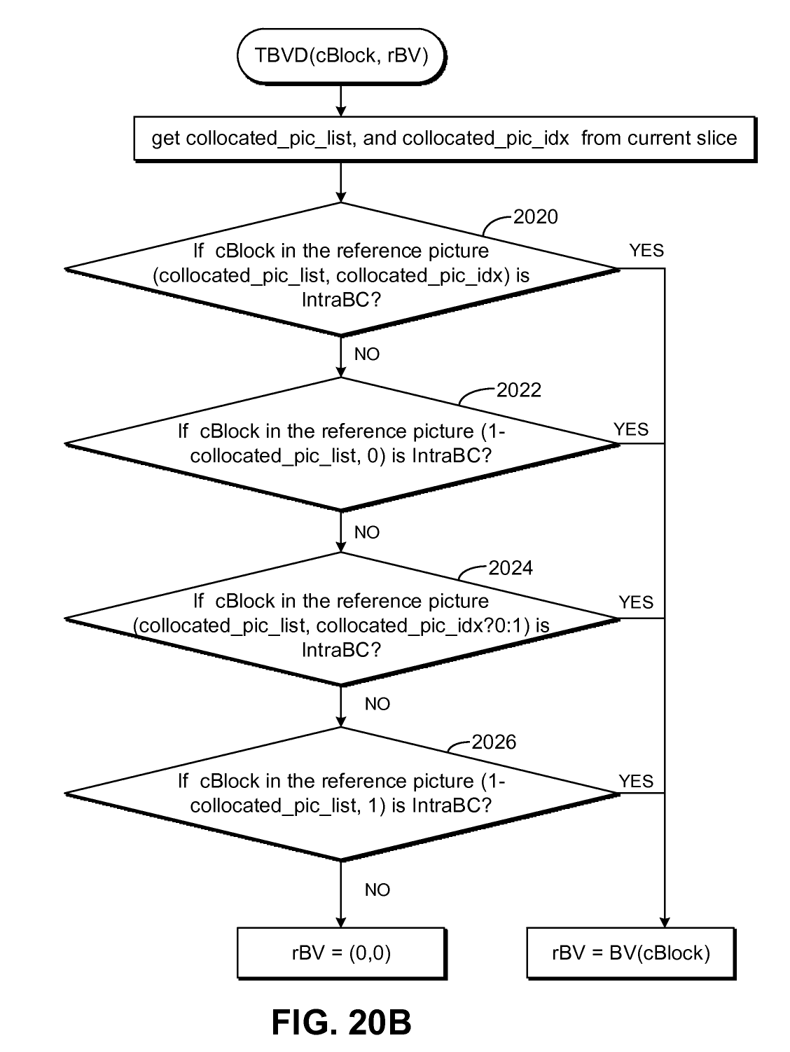

In exemplary embodiments disclosed herein, an additional BV predictor from the temporal reference pictures is added to the list above, after the spatial predictors SPa and SPb, but before the last predictors LPa and LPb. FIGS. 20A and 20B are two flow charts illustrating use of a temporal BV predictor derivation for the given block cBlock, in which cBlock is the block to be checked and rBV is the returned block vector. A BV of (0,0) is invalid. The embodiment of FIG. 20A uses only one collocated reference picture, while FIG. 20B uses at most four reference pictures. The design of FIG. 20A is compliant with the current requirements for TMVP derivation in HEVC, which also only uses one collocated reference picture. The collocated picture for TMVP is signaled in the slice header using two syntax elements, one indicating the reference picture list and the second indicating the reference index of the collocated picture (step 2002). If cBlock in the reference picture (collocatedpic_list, collocatedpic_idx) is IntraBC (step 2004), then the returned block vector rBV is the block vector of the checked block cBlock (step 2006), otherwise no valid block vector is returned (step 2008). For TBVP, the collocated picture can be the same as that for TMVP. In this case, no additional signaling is needed to indicate the collocated picture used for TBVP. The collocated picture for TBVP can also be different from that for TMVP. This allows more flexibility because the collocated picture for BV prediction can be selected by considering BV prediction efficiency. In this case, the collocated picture for TBVP and TMVP will be signaled separately by adding syntax elements specific for TBVP in the slice header.

The embodiment of FIG. 20B can give improved performance. In the FIG. 20B design, the first two reference pictures in each list (a total of four) will be checked as follows. In step 2020, the collocated picture signaled in the slice header is checked (denote its list as colPicList and its index as colPicIdx). In step 2022, the first reference picture in the list oppositeList(colPicList) is checked. In step 2024, the second reference picture in the list colPicList is checked, if the collocated picture is the first reference picture in list colPicList; otherwise, the first reference picture in list colPicList is checked. In step 2026, the second reference picture in the list oppositeList(colPicList) is checked.

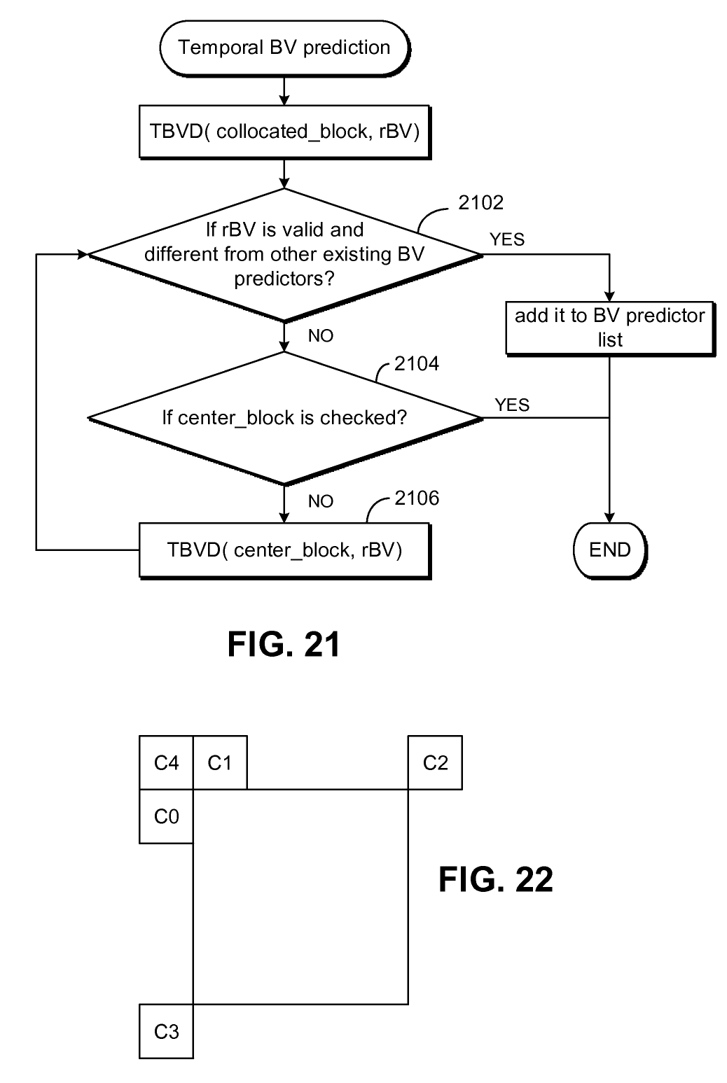

FIG. 21 illustrates an exemplary method of temporal BV predictor generation for BV prediction. Two block positions in the reference pictures will be checked as follows. The collocated block (bottom right of corresponding block in reference picture) is checked in step 2102. The alternative collocated block (the center block of the corresponding PU in the reference picture) is checked by performing steps 2104, 2106 and then repeating step 2102 on the center block. Only the unique BV will be added in the BV predictor list. In existing AMVP design, two sets of motion vectors stored in two lists (list_0 and List_1) of the collocated picture will be checked to derive MV predictors, and the motion vector of the collocated block (or the alternative collocated block) may be scaled using equation (1) and then used as MV predictor. If this existing AMVP method is directly used for BV prediction as in (Li 2014) (Xu 2014), the chance that a temporal BV predictor cannot be found is high because the BV is always uni-predicted and hence only one list (list_0) in the collocated picture can be used for BV predictor derivation. The more sophisticated design in FIG. 20B addresses this problem by checking multiple reference pictures for TBVP derivation; compared to using only one reference picture for TBVP, the design in FIG. 20B achieves better coding efficiency.

In single layer HEVC and current SCC extension design, the coded motion field can have very fine granularity in that motion vectors can be different for each 4×4 block. In order to save storage, the motion field of all reference pictures used in TMVP is compressed. After motion compression, motion information of coarser granularity is preserved: for each 16×16 block, only one set of motion information (including prediction mode such as uni-prediction or bi-prediction, one or both reference indexes in each list, one or two MVs for each reference) is stored. For the proposed TBVP, all block vectors may be stored together with motion vectors as part of the motion field (except that the BVs are always uni-prediction using only one list, such as list_0). Such an arrangement allows the block vectors used for TBVP to be naturally compressed together with regular motion vectors. Because this arrangement applies the same compression method as that for motion vector compression, BV compression can be carried out in a transparent manner during MV compression. There are other methods for BV compression. For example, during motion compression, BVs or MVs within 16×16 block may be distinguished. And whether BV or MV is stored for the 16×16 block may be determined as follows. First, it is determined whether BV or MV is dominant in the current 16×16 block. If the number of BVs is greater than the number of MVs, then BV is dominant Otherwise MV is dominant. If BV is dominant, then it can use the medium or the mean of all BVs within that 16×16 block as the compressed BV for that whole 16×16 block. Otherwise, if MV is dominant, the existing motion compression method is applied.

The list of BV predictors in an exemplary embodiment of a TBVP system is selected from a list of spatial predictors, temporal predictor, last predictors, and defaults predictors, as follows. First, an ordered list containing 7 BV candidate predictors is formed as follows. The list consists of 2 spatial predictors, 1 temporal predictor, 2 last predictors, and 2 default predictors. (1) Spatial predictor Spa. This is the first spatial predictor from bottom left neighboring PU A1, as shown in FIG. 19. (2) Spatial predictor SPb. This is the second spatial predictor from top right neighboring PU B1, as shown in FIG. 19. (3) Temporal predictor TSa. This is the temporal predictor derived from TBVP. (4) Last predictor LPa. This is the predictor from the last IntraBC coded PU in the current CTU. (5) Last predictor LPb. This is the second last predictor from an earlier IntraBC coded PU in the current CTU. When available and valid, LPb is different from LPa (this is guaranteed by checking that a newly coded BV is different from the existing 2 last predictors and only adding it as a last predictor if so). (6) Default predictor DPa. This predictor is set to (−2*widthPU, 0), where widthPU is the width of current PU. (7) Default predictor DPb. This predictor is set to (−widthPU, 0), where widthPU is the width of current PU. The ordered list of 7 BV candidate predictors is scanned from the first candidate predictor to the last candidate predictor. Valid and unique BV predictors are added to the final list of at most 2 BV predictors.

Intra Block Copy Merge Mode with TBVP.

In embodiments in which IntraBC and inter mode is distinguished by intra_bc_flag at the PU level, it is possible to optimize inter merge and IntraBC merge separately. For the inter merge process, all spatial neighboring blocks and temporal collocated blocks coded using IntraBC, intra, or palette mode will be excluded; only those blocks coded using inter mode with temporal motion vectors will be considered as candidates. This increases the number of useful candidates for inter merge. In the method proposed in (Li 2014) (Xu 2014), if temporal collocated blocks are coded using IntraBC, its block vector is usually excluded because the block vector is classified as long-term motion, and the first reference picture in colPicList is usually a regular short term reference picture. Although this method usually prevents a block vector from temporal collocated blocks from being included, this method can fail when the first reference picture also happens to be a long-term reference picture. Therefore, in this disclosure, at least three alternatives are proposed to address this problem.

The first alternative is to check the value of intra_bc_flag instead of checking the long-term property. However, this first alternative requires the values of intra_bc_flag for all reference pictures to be stored (in addition to the motion information already stored). One way to reduce the additional storage requirement is to compress the values of intra_bc_flag in the same way as motion compression used in HEVC. That is, instead of storing intra_bc_flag of all PUs, intra_bc_flag can be stored for larger block units such as 16×16 blocks.

In the second alternative, the reference index is checked. The reference index of IntraBC PU is equal to the size of list_0 (because it is the pseudo reference picture placed at the end of list_0), whereas the reference index of inter PU in list_0 is smaller than the size of list_0.

In the third alternative, the POC value of the reference picture referred by the BV is checked. For a BV, the POC of the reference picture is equal to the POC of the collocated picture, that is, the picture that the BV belongs to. If the BV field is compressed in the same way as the MV field, that is, if the BV of all reference pictures are stored for 16×16 block units, then the second and the third alternatives do not incur an additional storage requirement. Using any of the three proposed alternatives, it is possible to ensure that BVs are excluded from the inter merge candidate list.

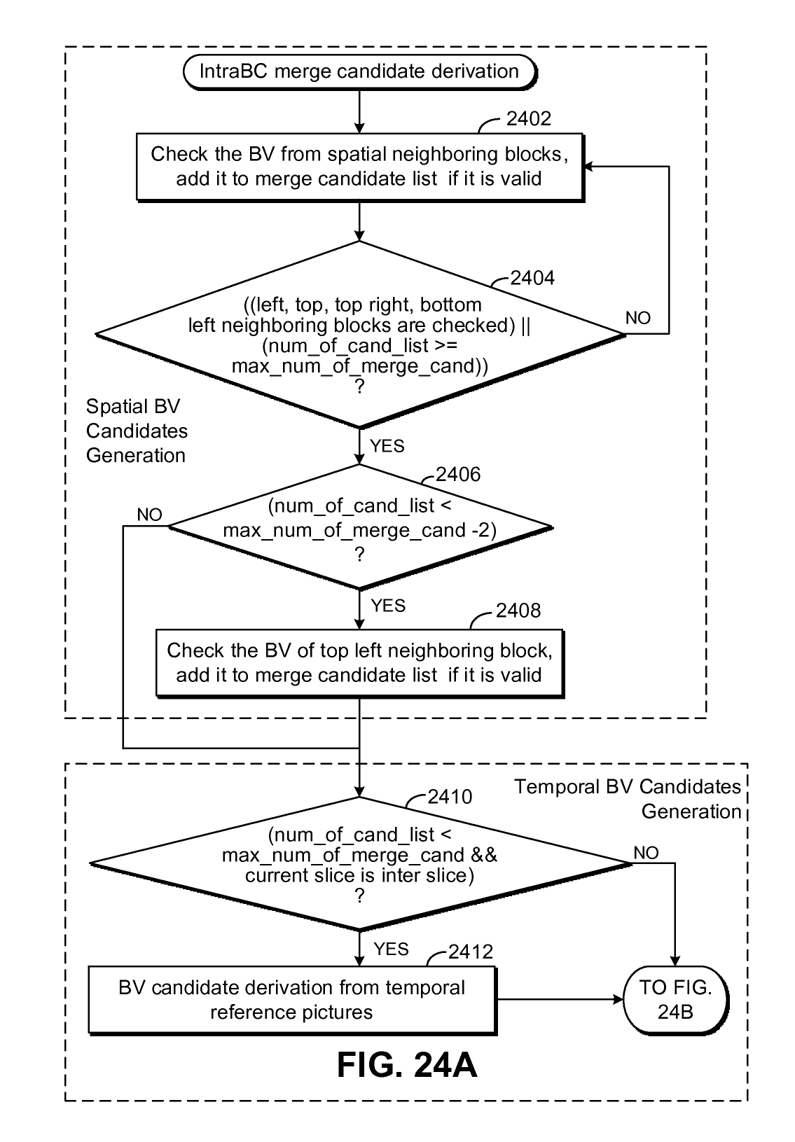

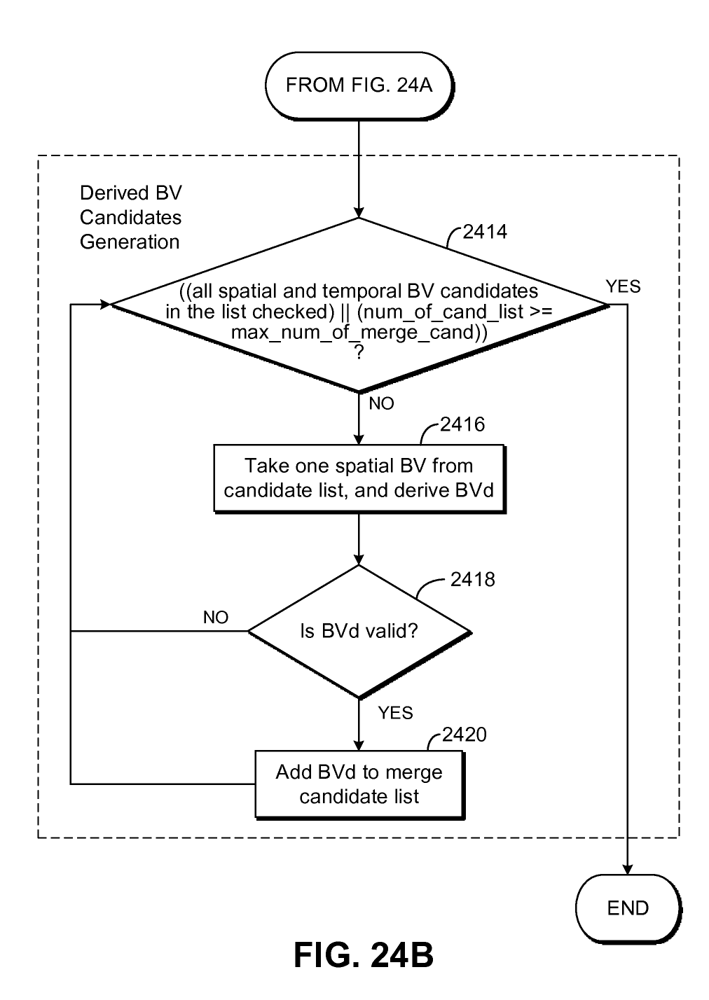

For IntraBC merge, only those IntraBC blocks will be considered as candidates for IntraBC merge mode. For a temporal collocated block, only the motion field in one list such as list_0 will be checked if it is long-term or short-term because BV uses uni-prediction. FIGS. 24A-24B provide a flow chart illustrating a proposed IntraBC merge process according to some embodiments. Steps 2410 and 2412 operate to consider temporal collocated blocks. In this embodiment, there are three kinds of IntraBC merge candidates and they are generated in order: (1) BV from spatial neighboring blocks (steps 2402-2408); (2) BV from temporal reference picture, as discussed in the section entitled “Temporal block vector prediction (TBVP)” (steps 2410-2412); (3) derived BV from block vector derivation process with those spatial and temporal BV candidates (steps 2414-2420). FIGS. 23A-B show the spatial blocks (C0-C4), and one temporal block (C5) if TBVP only uses one reference picture (FIG. 23A), or four temporal blocks (C5-C8) if TBVP uses four reference pictures (FIG. 23B), used in the generation of IntraBC merge candidates. Different from reference picture used in motion compensation, the reference picture for intra block copy prediction is partial reconstructed picture as shown in FIG. 18. Therefore, in an exemplary embodiment, a new condition is added when deciding whether a BV merge candidate is valid or not; specifically, if the BV candidate will use any reference pixel outside of the current slice or any reference pixel not yet decoded, then this BV candidate is regarded as invalid for the current PU. In summary, the IntraBC merge candidate list is generated as follows (as shown in FIGS. 24A-B).

In steps 2402-2404 check the neighboring blocks. Specifically, check left neighboring block C0. If C0 is IntraBC mode and its BV is valid for the current PU, then add it to the list. Check top neighboring block C1. If C1 is IntraBC mode and its BV is valid for the current PU and unique compared to existing candidates in the list, then add it to the list. Check top right neighboring block C2. If C2 is IntraBC mode and its BV is valid and unique, then add it to the list. Check bottom left neighboring block C3. If C3 is IntraBC mode and its BV is valid and unique, then add it to the list.

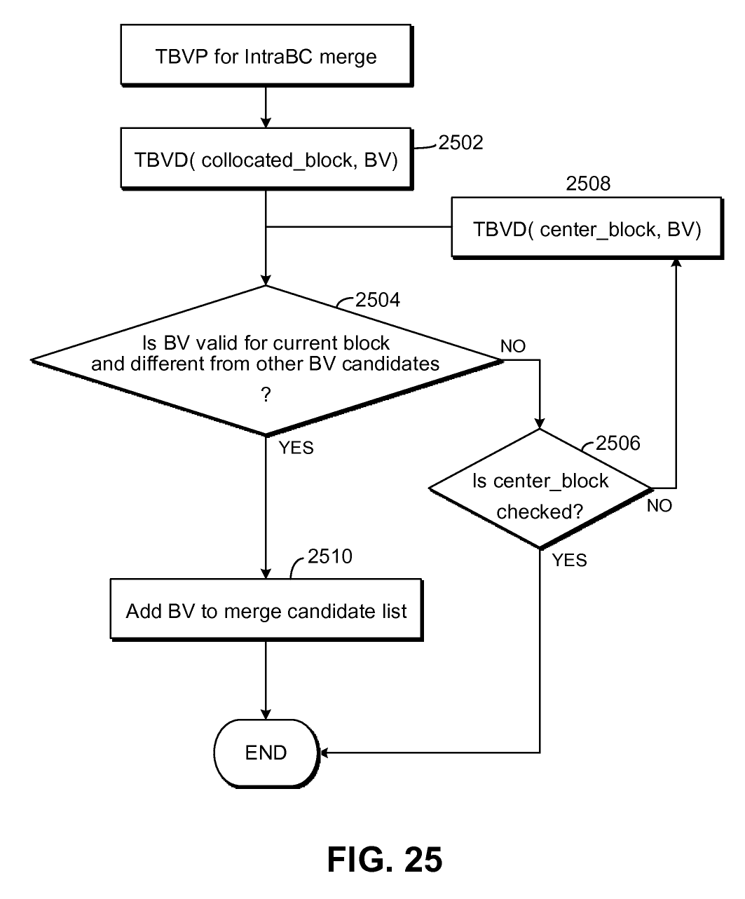

If it is determined in step 2406 that there are at least two vacant entries in the list, then check top left neighboring block C4 in step 2408. If C4 is IntraBC mode and its BV is valid and unique, then add it to the list. If it is determined in step 2410 that the list is not full and the current slice is an inter slice, then in step 2412, check the BV predictor with the TBVP method described above. An example of the process is shown in FIG. 25. If it is determined in step 2414 that the list is not full, the list is filled in steps 2416-1420 using the block vector derivation method using spatial and temporal BV candidates from the previous steps.

The flow chart of step 2416 is shown in FIG. 25. In steps 2502-2504, the collocated block in the collocated reference picture is checked (if the simple design in FIG. 23A is used), or in 4 reference pictures (2 in each lists) in order (if the more sophisticated design in FIG. 23B is used). When the process gets one valid BV candidate, and this candidate is different from all existing merge candidates in the list (step 2504), the candidate is added to the list in step 2510) and the process stops. Otherwise, the process continues to check the alternative collocated block (center block position of the corresponding PU in the temporal reference picture) in the same way using steps 2506, 2508, and 2504.

### IntraBC Skip Mode.

IntraBC CU as an inter mode can be coded in skip mode. For a CU coded using intraBC skip mode, the CU's partition size is 2N×2N and all quantized coefficients are zero. Therefore, after the CU level indication of intraBC skip, no other information (such as partition size and those coded block flags in the root of transform units) need to be coded for the CU. This can be very efficient in terms of signaling. Simulations show that the proposed IntraBC skip mode improves intra slice coding efficiency. However for inter slice (P_SLICE or B_SLICE), an additional intra_bc_skip_flag is added to differentiate from the existing inter skip mode. This additional flag brings an overhead for the existing inter skip mode. Because in inter slices, the existing inter skip mode is a frequently used mode for many CUs, especially when the quantization parameter is large, causing an overhead increase for inter skip mode signaling is undesirable, as it may negatively affect the efficiency of inter skip mode. Therefore, in some embodiments, IntraBC skip mode is enabled only in intra slices, and intraBC skip mode is disallowed in inter slices.

### Coding Syntax and Semantics.

An exemplary syntax change of IntraBC signaling scheme proposed in this disclosure can be illustrated with reference to proposed changes to the SCC draft specification, R. Joshi, J. Xu, “HEVC Screen Content Coding Draft Text 1”, JCTVC-R1005, July 2014, Sapporo, JP. The syntax change of IntraBC signaling scheme proposed in this disclosure is listed in Appendix A. The changes employed in embodiments of the present disclosure are illustrated using double-strikethrough for omissions and underlining for additions. Note that compared to the method in (Li 2014) and (Xu 2014), the syntax element intra_bc_flag is placed before the syntax element merge_flag at the PU level. This allows the separation of intraBC merge process and inter merge process, as discussed earlier.

In exemplary embodiments, an intra_bc_flag[x0][y0] equal to 1 specifies that the current prediction unit is coded in intra block copying mode. An intra_bc_flag[x0][y0] equal to 0 specifies that the current prediction unit is coded in inter mode. When not present, the value of intra_bc_flag is inferred as follows. If the current slice is an intra slice, and the current coding unit is coded in skip mode, the value of intra_bc_flag is inferred to be equal to 1. Otherwise, intra_bc_flag[x0][y0] is inferred to be equal to 0. The array indices x0 and y0 specify the location (x0, y0) of the top-left luma sample of the considered coding block relative to the top-left luma sample of the picture.

### Merge Process for the Unified IntraBC and Inter Framework.

In order to address problems of using the existing HEVC inter merge process as discussed earlier, the following changes to the existing merge process are employed in some embodiments.

First, if a spatial neighbor contains a block vector, a block vector validation step is applied before it is added to the spatial merge candidate list. The block vector validation step will check if the block vector is applied to predict the current PU, whether it will require any reference samples that are not yet reconstructed (therefore not yet available) in the pseudo reference picture due to encoding order. Additionally, the block vector validation step will also check if the block vector requires any reference pixels outside of the current slice boundary. If yes for either of the two cases, then the block vector will be determined to be invalid and will not be added into the merge candidate list.

The second problem is related to the TBVP process being “broken” in the current design, where, if the collocated block in the collocated picture contains a block vector, then that block vector will typically not be considered as a valid temporal merge candidate due to the “long term” vs “short term” mismatch previously discussed. In order to address this problem, in an embodiment of this disclosure, an additional step is added to the inter merge process described in (Merge-Step 1) through (Merge-Step 8). Specifically, the additional step invokes the TMVP process using the reference index in L0 or L1 of the pseudo reference picture, instead of using the fixed reference index with the fixed value of 0 (the first entry on the respective reference picture list). Because this additional step gives a long term reference picture (that is, the pseudo reference picture) to the TMVP process, if the collocated PU contains a block vector that is considered a long term MV, the mismatch will not happen, and the block vector from the collocated PU will now be considered as a valid temporal merge candidate. This additional step may be placed immediately before or after (Merge-Step 6), or it may be placed in any other position of the merge steps. Where this additional step is placed in the merge steps may depend on the slice type of the picture currently being coded. In another embodiment of this disclosure, this new step that invokes the TMVP process using the reference index of the pseudo reference picture may replace the existing TMVP step that uses reference index of fixed value 0, that is, it may replace the current (Merge-Step 6).

### Derived Block Vectors.

Embodiments of the presently disclosed systems and methods use block vector derivation to improve intra block copy coding efficiency. Block vector derivation is described in further detail in U.S. Provisional Patent Application No. 62/014,664, filed Jun. 19, 2014, and U.S. patent application Ser. No. 14/743,657, filed Jun. 18, 2015. The entirety of these applications is incorporated herein by reference.

Among the variations discussed and described in this disclosure are (i) block vector derivation in intra block copy merge mode and (ii) block vector derivation in intra block copy with two block vectors mode.

Depending on the coding type of a reference block, a derived block vector or motion vector can be used in different ways. One way is to use the derived BV as merge candidates in IntraBC merge mode. Another way is to use the derived BV/MV for normal IntraBC prediction.

FIG. 27 is a diagram illustrating an example of block vector derivation. Given the block vector, the second block vector can be derived if the reference block pointed to by the given BV is an IntraBC coded block. The derived block vector is calculated in Eq. (5). FIG. 27 shows this kind of block vector derivation generally at 2700.

BVd=BV0+BV1 (5)

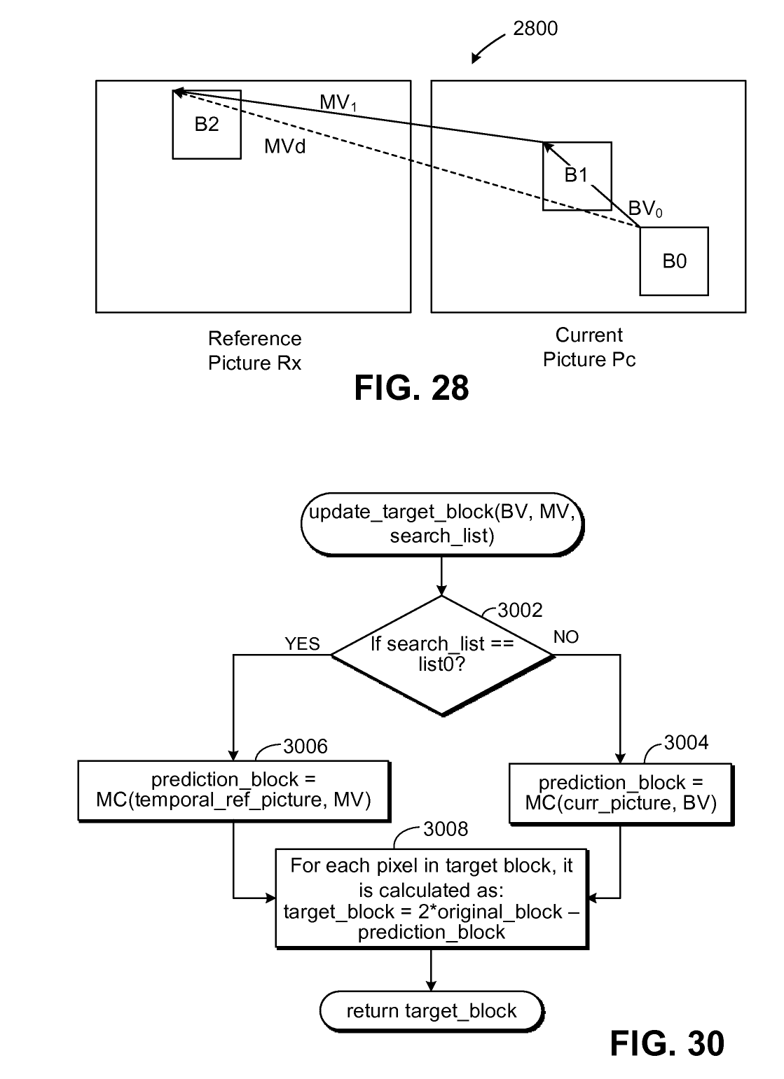

FIG. 28 is a diagram illustrating an example motion vector derivation. If the block pointed to by the given BV is an inter coded block, then the MV can be derived. FIG. 28 shows the MV derivation case generally at 2800. If block B1 in FIG. 28 is uni-prediction mode, then the derived motion MVd in integer pixel for block B0 is,

MVd=BV0+((MV1+2)>>2) (6)

and the reference picture is the same as that of B1. In HEVC, the normal motion vector is quarter pixel precision, and the block vector is integer precision. Integer pixel motion for derived motion vector is used by way of example here. If the block B1 is bi-prediction mode, then there are at least two ways to perform motion vector derivation. One is to derive two motion vectors and reference indices in the same manner as above for uni-prediction mode. Another is to select the motion vector from the reference picture with smaller quantization parameter (high quality). If both reference pictures have the same quantization parameter, then the motion vector may be selected from the closer reference picture in picture order of count (POC) distance.

### Incorporating Derived Block Vectors in Merge Candidate List.

To include derived block vectors from into the merge candidate list in the inter merge process, at least two methods may be employed. In the first method, an additional step is added to the inter merge process (Merge-Step 1) through (Merge-Step 8). After the spatial candidate and the temporal candidates are derived, that is, after (Merge-Step 6), for each of the candidate in the merge candidate list, it is decided whether the candidate vector is a block vector or a motion vector. This decision may be made by checking to see if the reference picture referred to by this candidate vector is the pseudo reference picture. If the candidate vector is a block vector, then the block vector derivation process may be invoked to obtain the derived block vector. Then, the derived block vector, if unique and valid, may be added as another merge candidate into the merge candidate list.

In a second embodiment, the derived block vector may be added by using the existing TMVP process. In the existing TMVP process, the collocated PU in the collocated picture, as depicted in FIG. 15, is spatially located at the same position of the current PU in the current picture being coded, and the collocated picture is identified by the slice header syntax element. In order to get the derived block vector, the collocated picture may be set to the pseudo reference picture (which is currently prohibited in the design of (Pang October 2014)), the collocated PU may be set to the PU that is pointed to by an existing candidate vector, and the reference index may be set to that of the pseudo reference picture. Denote an existing candidate vector as (BVCx, BVCy) (this could be one of the spatial candidates or the temporal candidate), and denote the block position of the current PU to be (PUx, PUy), then the collocated PU will be set at (PUx+BVCx, PUy+BVCy). Then, by invoking the TMVP process with these settings, the TMVP process will return the block vector of the collocated PU (if any). Denote this returned block vector as (BVcolPUx, BVcolPUy). The derived block vector is calculated as (BVDx, BVDy)=(BVCx+BVcolPUx, BVCy+BVcolPUy). This derived block vector, if unique and valid, may then be added as a new merge candidate to the list. The derived block vector may be calculated using each of the existing candidate vectors, and all unique and valid derived block vectors may be added to the merge candidate list, as long as the merge candidate list is not full.

### Additional Merge Candidates.

In order to further improve the coding efficiency, more block vector merge candidates may be added if the merge candidate list is not full. In X. Xu, T.-D. Chuang, S. Liu, S. Lei, “Non-CE2: Intra BC merge mode with default candidates’, JCTVC-S0123, October 2014, default block vectors calculated based on the CU block size are added to the merge candidate list. In this disclosure, similar default block vectors are added. These default block vectors may be calculated based on the PU block size, rather than the CU block size. Further, these default block vectors may be calculated as a function not only of the PU block size, but also the PU location in the CU. For example, denote the block position of the current PU relative to the top left position of the current coding unit as (PUx, PUy). Denote the width and height of current PU as (PUw, PUh). The default block vectors in order may be calculated as follows: (−PUx−PUw, 0), (−PUx−2*PUw, 0), (−PUy−PUh, 0), (−PUy−2*PUh, 0), (−PUx−PUw, −PUy−PUh). These default block vectors may be added immediately before or after the zero motion vectors in (Merge-Step 8), or they may be interleaved together with the zero motion vectors. Further, these default block vectors may be placed at different positions in the merge candidate list, depending on the slice type of the current picture.

In one embodiment, the following steps marked as (New-Merge-Step) may be used to derive a more complete and efficient merge candidate list. Note that although only “inter PU” is mentioned below, “inter PU” includes the “IntraBC PU” under the unified framework in (Li 2014), (Pang October 2014).
(New-Merge-Step 1) Check left neighboring PU A1. If A1 is an inter PU, and if its MV/BV is valid, then add its MV/BV to the candidate list.
(New-Merge-Step 2) Check top neighboring PU B 1. If B1 is an inter PU and its MV/BV is unique and valid, then add its MV/BV to the candidate list.
(New-Merge-Step 3) Check top right neighboring PU B0. If B0 is an inter PU and its MV/BV is unique and valid, then add its MV/BV to the candidate list.
(New-Merge-Step 4) Check bottom left neighboring PU A0. If A0 is an inter PU and its MV/BV is unique and valid, then add its MV/BV to the candidate list.
(New-Merge-Step 5) If the number of candidates is smaller than 4, then check top left neighboring PU B2. If B2 is an inter PU and its MV/BV is unique and valid, then add its MV/BV to the candidate list.
(New-Merge-Step 6) Invoke the TMVP process with reference index set to 0, the collocated picture as specified in the slice header, and the collocated PU as depicted in FIG. 15 to obtain the temporal MV predictor. If the temporal MV predictor is unique, add it to the candidate list.
(New-Merge-Step 7) Invoke the TMVP process with reference index set to that of the pseudo reference picture, the collocated picture as specified in the slice header, and the collocated PU as depicted in FIG. 15 to obtain the temporal BV predictor. If the temporal BV predictor is unique and valid, add it to the candidate list, if the candidate list is not full.
(New-Merge-Step 8) If the merge candidate list is not full, for each of the candidate vector obtained from (New-Merge-Step 1) to (New-Merge-Step 7) that is a block vector, apply the block vector derivation process using either of the two methods described above. If the derived block vector is valid and unique, add it to the candidate list.
(New-Merge-Step 9) If the merge candidate list is not full, and if the current slice is a B slice, then combinations of various merge candidates which were added to the current merge list during steps (New-Merge-Step 1) through (New-Merge-Step 8) are checked and added to the merge candidate list.
(New-Merge-Step 10) If the merge candidate list is not full, then default block vectors and zero motion vector with different reference picture combinations will be appended in the candidate list in an interleaved manner, until the list is full.

In some embodiments, the step “New-Merge-Step 10” for a B slice can be implemented in the following way. First, the validation of five default block vectors defined before is checked. If the BV makes any reference to those unreconstructed samples, or the samples outside the slice boundary, or the samples in the current CU, then it will treated as an invalid BV. If the BV is valid, it will be added in a list validDBVList, with the size of validDBVList being denoted as validDBVListSize. Second, the following MV pairs of the merge candidate with bi-prediction mode are added in order for those shared index until the merge candidate list is full:

{(0,i,mv0_x,mv0_y),(1,i,mv1_x,mv1_y)},

iε[0,Min(num_ref_idx_l0,num_ref_idx_l1))

If the i-th reference picture in list-0 is the current picture, then mv0_x and mv0_y are set as one of the default BVs:

mv0_x=validDBVList[dBVIdx][0]

mv0_y=validDBVList[dBVIdx][1]

dBVIdx=(dBVIdx+1)% validDBVListSize

and dBVIdx is set to zero at the beginning of “New-Merge-Step 10”. Otherwise, mv0_x and mv0_y are both set to zero. If the i-th reference picture in list-1 is the current picture, then mv1_x and mv1_y are set as one of the default BVs:

mv1_x=validDBVList[dBVIdx][0]

mv1_y=validDBVList[dBVIdx][1]

dBVIdx=(dBVIdx+1)% validDBVListSize

Otherwise, mv1_x and mv1_y are both set to zero.

If the merge candidate list is still not full, a determination is made of whether there is a current picture in the remaining reference pictures in the list having a larger size. If the current picture is found, then the following default BVs are added as merge candidates with uni-prediction mode in order until the merge candidate list is full:

bv_x=validDBVList[dBVIdx][0]

bv_y=validDBVList[dBVIdx][1]

dBVIdx=(dBVIdx+1)% validDBVListSize

If the current picture is not found, then the following MVs are appended repeatedly until the merge candidate list is full.

{(0,0,mv0_x,mv0_y),(1,0,mv1_x,mv1_y)}

Where mv0_x, mv0_y, mv1_x and mv1_y are derived in the manner described above.

Some embodiments described herein can be implemented using revisions to Section 8.5.3.2.5 (“Derivation process for zero motion vector merging candidates” in the draft specification of (Joshi 2014). Proposed revisions to the draft specification are set forth in Appendix B of this disclosure, with particular revisions being indicated in boldface and deletions being indicated in double strikethrough.

In the current design of the unified IBC and inter framework, the current picture is treated as a normal long term reference picture. No additional restrictions are imposed on where the current picture can be placed in List_0 or List_1 or on whether the current picture could be used in bi-prediction (including bi-prediction of BV and MV and bi-prediction of BV and BV). This flexibility may not be desirable because the merge process described above would have to search for the reference picture list and the reference index that represent the current picture, which complicates the merge process. Additionally, if the current picture is allowed to appear in both list_0 and list_1 as in the current design, then bi-prediction using BV and BV combination will be allowed. This may increase the complexity of the motion compensation process, but with limited performance benefits. Therefore, it may be desirable to impose certain constraints on the placement of the current picture in the reference picture list. In various embodiments, one or more of the following constraints and their combinations may be imposed. In a first constraint, the current picture is allowed to be placed in only one reference picture list (e.g., List_0), but not both reference picture lists. This constraint disallows the bi-prediction of BV and BV. In a second constraint, the current picture is only allowed to be placed at the end of the reference picture list. This way the merge process described above can be simplified because the placement of the current picture is known.

### Decoding Process for Reference Picture Lists Construction.

In the current design, the process of constucting reference picture lists is invoked at the beginning of the decoding process for each P or B slice. Reference pictures are addressed through reference indices as specified in subclause 8.5.3.3.2. A reference index is an index into a reference picture list. When decoding a P slice, there is a single reference picture list RefPicList0. When decoding a B slice, there is a second independent reference picture list RefPicList1 in addition to RefPicList0.

At the beginning of the decoding process for each slice, the reference picture lists RefPicList0 and, for B slices, RefPicList1 are derived as follows. The variable NumRpsCurrTempList0 is set equal to Max(num_ref_idx_l0_active_minus1+1, NumPicTotalCurr) and the list RefPicListTemp0 is constructed as shown in Table 1.

TABLE 1
rIdx = 0
while( rIdx < NumRpsCurrTempList0 ) {

for( i = 0; i < NumPocStCurrBefore && rIdx < NumRpsCurrTempList0; rIdx++,
i++)

RefPicListTemp0[ rIdx ] = RefPicSetStCurrBefore[ i ]

for( i = 0; i < NumPocStCurrAfter && rIdx < NumRpsCurrTempList0; rIdx++,
i++)

RefPicListTemp0[ rIdx ] = RefPicSetStCurrAfter[ i ]

| | |
|---|---|
| if( curr_pic_as_ref_enabled_flag ) | † |

| | |
|---|---|
| RefPicListTemp0[ rIdx++ ] = currPic | † |

for( i = 0; i < NumPocLtCurr && rIdx < NumRpsCurrTempList0; rIdx++, i++ )

RefPicListTemp0[ rIdx ] = RefPicSetLtCurr[ i ]

}

The list RefPicList0 is constructed as shown in Table 2.

TABLE 2
for( rIdx = 0; rIdx <= num_ref_idx_l0_active_minus1; rIdx++)

RefPicList0[ rIdx ] = ref_pic_list_modification_flag_l0 ?
RefPicListTemp0[ list_entry_l0[ rIdx ] ] : RefPicListTemp0[ rIdx ]

When the slice is a B slice, the variable NumRpsCurrTempList1 is set equal to Max(num_ref_idx_l1_active_minus1+1, NumPicTotalCurr) and the list RefPicListTemp1 is constructed as shown in Table 3.

TABLE 3
rIdx = 0
while( rIdx < NumRpsCurrTempList1 ) {

for( i = 0; i < NumPocStCurrAfter && rIdx < NumRpsCurrTempList1; rIdx++,
i++)

RefPicListTemp1[ rIdx ] = RefPicSetStCurrAfter[ i ]

for( i = 0; i < NumPocStCurrBefore && rIdx < NumRpsCurrTempList1; rIdx++,
i++)

RefPicListTemp1[ rIdx ] = RefPicSetStCurrBefore[ i ]

| | |
|---|---|
| if( curr_pic_as_ref_enabled_flag ) | † |

| | |
|---|---|
| RefPicListTemp1[ rIdx++ ] = currPic | † |

for( i = 0; i < NumPocLtCurr && rIdx < NumRpsCurrTempList1; rIdx++, i++ )

RefPicListTemp1[ rIdx ] = RefPicSetLtCurr[ i ]

}

When the slice is a B slice, the list RefPicList1 is constructed as shown in Table 4.

TABLE 4
for( rIdx = 0; rIdx <= num_ref_idx_l1_active_minus1; rIdx++)

RefPicList1[ rIdx ] = ref_pic_list_modification_flag_l1 ?
RefPicListTemp1[ list_entry_l1[ rIdx ] ] : RefPicListTemp1[ rIdx ]

As indicated by the lines of the current design marked in the right-hand column with a dagger (\), the current picture is placed in one or more temporary reference picture lists, which may be subject to a reference picture list modification process (depending on the value of ref_pic_list_modification_l0/l1) before the final lists are constructed. To enable the current picture always to be placed at the end of the reference picture list, the current design is modified such that the current picture is directly appended to the end of the final reference picture list(s) and is not inserted into the temporary reference picture list(s).

Furthermore, in the current design, the flag curr_pic_as_ref_enabled_flag is signaled at the Sequence Parameter Set level. This means that if the flag is set to 1, then the current picture will be inserted into the temporary reference picture list(s) of all of the pictures in the video sequence. This may not provide sufficient flexibility for each individual picture to choose whether to use the current picture as a reference picture. Therefore, in one embodiment of this disclosure, slice level signaling (e.g., a slice level flag) is added to indicate whether the current picture is used to code the current slice. Then, this slice level flag, instead of the SPS level flag (curr_pic_as_ref_enabled_flag), is used to condition the lines marked with a dagger (t). When a picture is coded in multiple slices, the value of the proposed slice level flag is enforced to be the same for all the slices that correspond to the same picture.

### Complexity Restrictions for Unified IntraBC and Inter Framework.

As previously discussed, in the unified IntraBC and inter framework, it is allowed to apply bi-prediction mode using at least one prediction that is based on a block vector. That is, in addition to the conventional bi-prediction based on motion vectors only, the unified framework also allows bi-prediction using one prediction based on a block vector and another prediction based on a motion vector, as well as bi-prediction using two block vectors. This extended bi-prediction mode may increase the encoder complexity and the decoder complexity. Yet, coding efficiency improvement may be limited. Therefore, it may be beneficial to restrict bi-prediction to the conventional bi-prediction using two motion vectors, but disallow bi-prediction using (one or two) block vectors. In a first method to impose such restriction, the MV signaling may be changed at PU level. For example, when prediction direction signaled for the PU indicates bi-prediction, then the pseudo reference picture is excluded from the reference picture lists and the reference index to be coded is modified accordingly. In a second method to impose this bi-prediction restriction, bitstream conformance requirements are imposed to restrict any bi-prediction mode such that block vector that refers to the pseudo reference frame cannot be used in bi-prediction. For the merge process discussed above, with the proposed restricted bi-prediction, the (New-Merge-Step 9) will not consider any combination of block vector candidates.

An additional feature that can be implemented to further unify the pseudo reference picture with other temporal reference pictures is a padding process. For regular temporal reference pictures, when a motion vector uses samples outside of the picture boundary, the picture is padded. However, in the designs of (Li 2014), (Pang October 2014), block vectors are restricted to be within the boundary of the pseudo reference picture, and the picture is never padded. Padding the pseudo reference picture in the same manner as other temporal reference pictures may provide further unification.

Bi-Prediction Search for Bi-Prediction Mode with BV and MV.

In some embodiments, the block vector and motion vector are allowed to be combined to form bi-prediction mode for a prediction unit in the unified IntraBC and inter framework. This feature allows further improvement of coding efficiency in this unified framework. In the following discussion, this bi-prediction mode is referred to as BV-MV bi-prediction. There are different ways to exploit this specific BV-MV bi-prediction mode during the encoding process.

One method is to check those BV-MV bi-prediction candidates from an inter merge candidates derivation process. If the spatial or temporal neighboring prediction unit is BV-MV bi-prediction mode, then it will be used as one merge candidate for the current prediction unit. As discussed above with respect to “Merge Step 7,” if the merge candidate list is not full, and the current slice is a B slice (allowing bi-prediction), the motion vector from reference picture list list_0 of one existing merge candidate and the motion vector from reference picture list list_1 of another existing merge candidate are combined to form a new bi-prediction merge candidate. In the unified framework, this newly generated bi-prediction merge candidate can be BV-MV bi-prediction. If the BV-MV bi-prediction candidate is selected as best merge candidate and the merge mode is selected as best coding mode for one prediction unit, only the merge flag and merge index associated with this BV-MV bi-prediction candidate will be signaled. The BV and MV will not be signaled explicitly, and the decoder will infer them via the merge candidate derivation process, which parallels the process performed at the encoder.

In another embodiment, bi-prediction search is applied for BV-MV bi-prediction mode for one prediction unit at the encoder and BV and MV, respectively, are signaled if this mode is selected as the best coding mode for that PU.

The conventional bi-prediction search with two MVs in the motion estimation process in SCC reference software is an iterative process. Firstly, uni-prediction search in both list_0 and list_1 is performed. Then, bi-prediction is performed based on these two uni-prediction MVs in list_0 and list_1. The method fixes one MV (e.g. list_0 MV), and refines another MV (e.g. list_1 MV) within a small search window around the MV to be refined (e.g. list_1 MV). The method then refines the MV of the opposite list (e.g. list_0 MV) in the same way. The bi-prediction search stops when the number of searches meets a pre-defined threshold, or the distortion of bi-prediction is smaller than a pre-defined threshold.

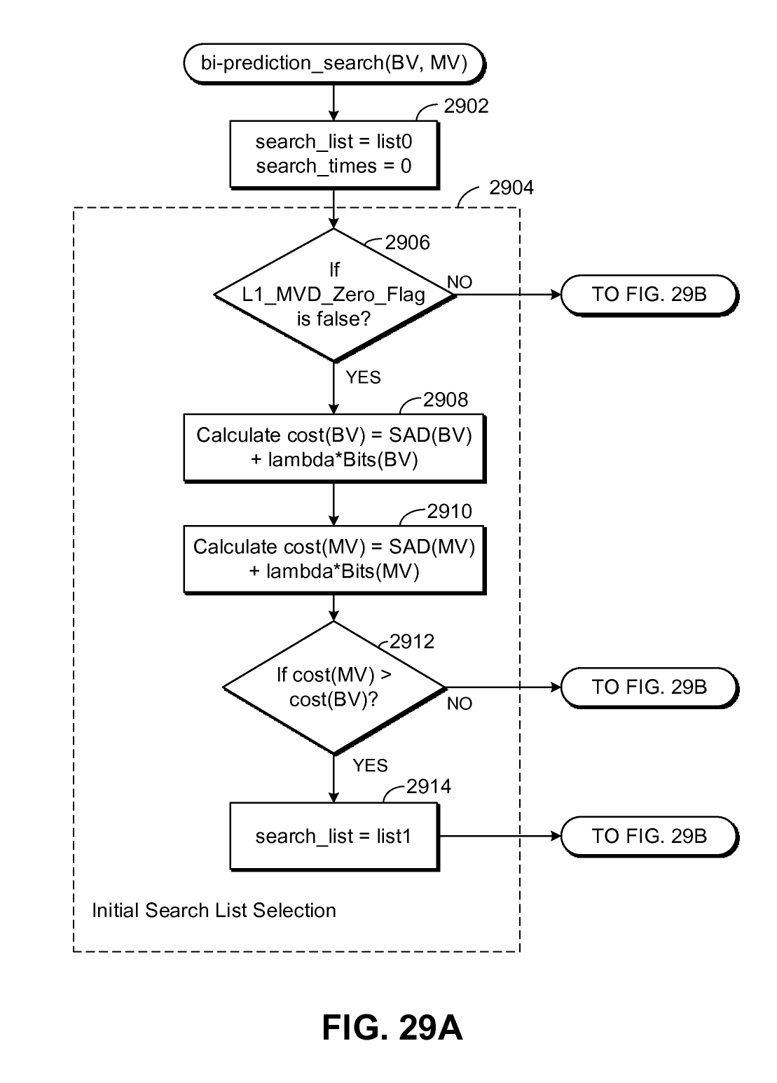

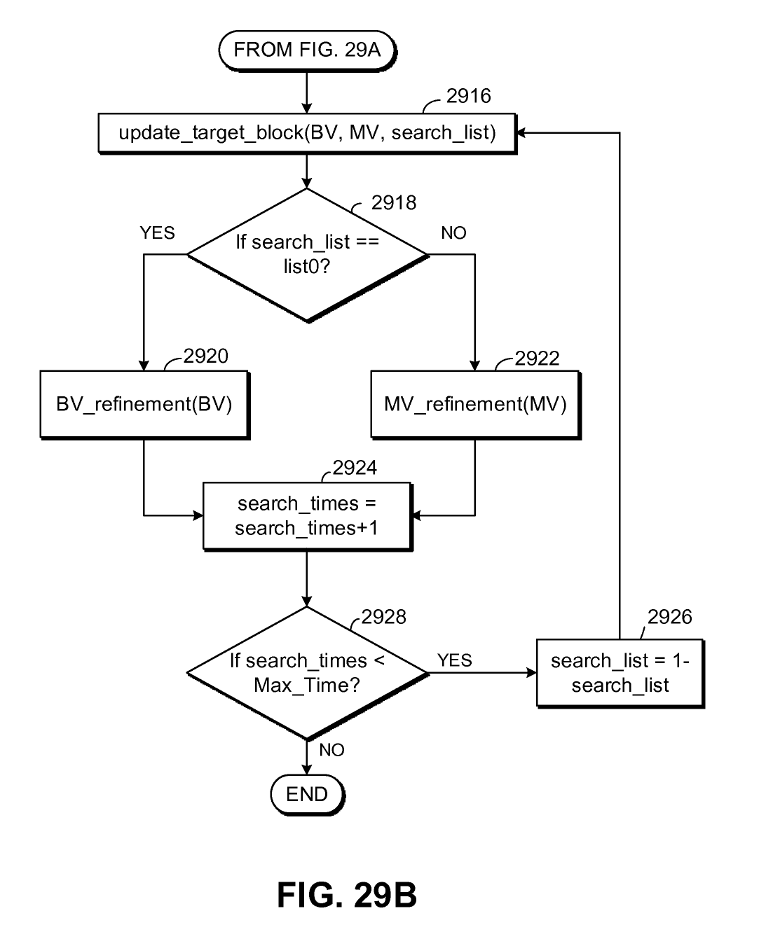

For the proposed BV-MV bi-prediction search disclosed herein, the best BV of IntraBC mode and the best MV of normal inter mode are stored. Then the stored BV and MV are used in the BV-MV bi-prediction search. A flow chart of the BV-MV bi-prediction search is depicted in FIGS. 29A-B.

One difference from MV-MV bi-prediction search is that the BV search is performed for block vector refinement, which may be different from MV refinement because the BV search algorithm may be designed differently from the MV search algorithm. In the example of FIGS. 29A-B, it is assumed that the BV is from list_0 and the MV is from list_1, without loss of generality. The initial search list is selected by comparing the individual rate distortion cost for BV and for MV, and choosing the one that has bigger cost. For example, if the cost of BV is larger, then list_0 is selected as the initial search list, such that the BV may be further refined to provide better prediction. The BV refinement and MV refinement are performed iteratively.

In the method of FIGS. 29A-B, the search_list and search_times are initialized in step 2902. An initial search list selection process 2904 is then performed. If an L1_MVD_Zero_Flag is false (step 2906), then the rate distortion cost of BV is determined in step 2908 and the rate distortion cost of MV is determined in step 2910. These costs are compared (step 2912), and if MV has a higher cost, the search list is switched to list_1. A target block update method (described in greater detail below) is performed in step 2916, and refinement of the BV or MV as appropriate is performed in steps 2918-2922. The counter search_times is incremented in step 2924, and the process is repeated with an updated search_list (step 2926) until Max_Time is reached (step 2928).

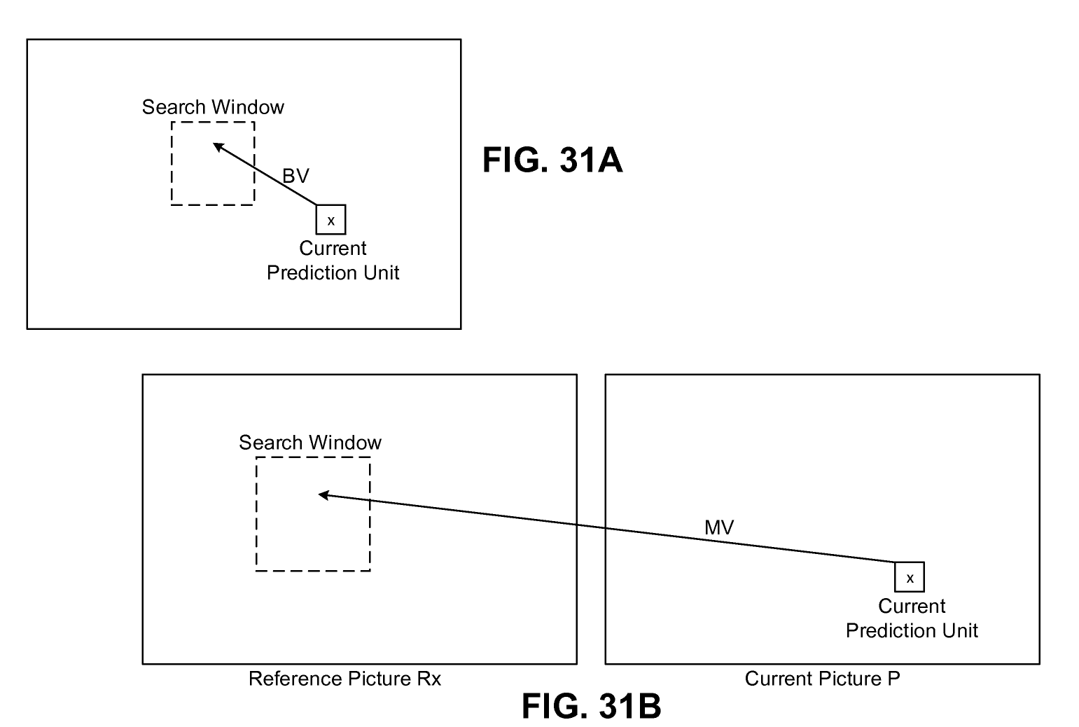

The target block update process performed before each round of BV or MV refinement is illustrated in the flow chart of FIG. 30. The target block for the goal of refinement is calculated by subtracting the prediction block of the fixed direction (BV or MV) from the original block. In step 3002, it is determined based on search_list whether BV or MV is to be refined. If the BV is to be refined (steps 3004, 3008), the target block will be set equal to the original block minus the prediction block obtained with the MV from the last round of search. Conversely, if the MV is to be refined (steps 3006, 3008), the target block will be set equal to the original block minus the prediction block obtained with the BV from the last round of search. Then, the next round of BV or MV search refinement includes performing a BV/MV search to try to match the target block. The search window for BV refinement is shown in FIG. 31A, and the search window for MV refinement is shown in FIG. 31B. The search window for BV refinement can be different from that of MV refinement.

In one embodiment of the proposed BV-MV bi-prediction search, this explicit bi-prediction search is only performed when the motion vector resolution is fractional for that slice. As discussed above, integer motion vector resolution indicates the motion compensated prediction is quite good, so it would be difficult for BV-MV bi-prediction search to improve prediction further. By disabling BV-MV bi-prediction search when motion vector resolution is integer, another benefit is that the encoding complexity can be reduced compared to when BV-MV bi-prediction is always performed. A BV-MV bi-prediction search can be performed selectively based on partition size to control encoding complexity further. For example, the BV-MV bi-prediction search may be performed only when motion vector resolution is not integer and the partition size is 2N×2N.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A video coding method comprising:
identifying a candidate block vector for prediction of a first video block, wherein the first video block is in a current picture, and wherein the candidate block vector is a first block vector used for prediction of a second video block in a temporal reference picture; and
coding the first video block with intra block copy coding using the candidate block vector as a predictor of the first video block.

2. The method of claim 1, wherein coding the first video block includes generating a bitstream coding the current picture as a plurality of blocks of pixels, and wherein the bitstream includes an index identifying the first block vector.

3. The method of claim 1, wherein coding the first video block includes receiving a bitstream coding the current picture as a plurality of blocks of pixels, and wherein the bitstream includes an index identifying the first block vector.

4. The method of claim 1, further comprising generating a merge candidate list, wherein the merge candidate list includes the first block vector, and wherein coding the first video block includes providing an index identifying the first block vector in the merge candidate list.

5. The method of claim 4, wherein the merge candidate list further includes at least one default block vector.

6. The method of claim 1, further comprising:
generating a merge candidate list, wherein the merge candidate list includes a set of motion vector merge candidates and a set of block vector merge candidates;
wherein coding the first video block includes:
providing the first video block with a flag identifying that the predictor is in the set of block vector merge candidates; and
providing the first video block with an index identifying the first block vector within the set of block vector merge candidates.

7. The method of claim 1, wherein coding the first video block comprises:
receiving a flag identifying that the predictor is a block vector;
generating a merge candidate list, wherein the merge candidate list includes a set of block vector merge candidates; and
receiving an index identifying the first block vector within the set of block vector merge candidates.

8. A video coding method comprising:
forming a list of motion vector merge candidates and a list of block vector merge candidates for a prediction unit;
selecting one of the merge candidates as a predictor;
providing the prediction unit with a flag identifying whether the predictor is in the list of motion vector merge candidates or in the list of block vector merge candidates; and
providing the prediction unit with an index identifying the predictor from within the identified list of merge candidates.

9. The method of claim 8, wherein at least one of the block vector merge candidates is generated using temporal block vector prediction.

10. A video coding method comprising:
forming a list of merge candidates for a prediction unit, wherein each merge candidate is a predictive vector, and wherein at least one of the predictive vectors is a first block vector from a temporal reference picture;
selecting one of the merge candidates as a predictor; and
providing the prediction unit with an index identifying the predictor from within the identified set of merge candidates.

11. The method of claim 10, further comprising adding a predictive vector to the list of merge candidates only after determining that the predictive vector is valid and unique.

12. The method of claim 10, wherein the list of merge candidates further includes at least one derived block vector.

13. The method of claim 10, wherein the selected predictor is the first block vector.

14. The method of claim 10, wherein the first block vector is a block vector associated with a collocated prediction unit.

15. The method of claim 14, wherein the collocated prediction unit is in a collocated reference picture specified in a slice header.

16. A video coding method comprising:
identifying a set of merge candidates for a prediction unit, wherein the identification of the set of merge candidates includes adding at least one candidate with a default block vector;
selecting one of the candidates as a predictor; and
providing the prediction unit with an index identifying the merge candidate from within the identified set of merge candidates.

17. The method of claim 16, wherein the default block vector is selected from a list of default block vectors.

18. The method of claim 16, wherein the set of merge candidates additionally includes at least one zero motion vector.

19. The method of claim 18, wherein the at least one default block vector and the at least one zero motion vector are arranged in an interleaved manner in the set of merge candidates.

20. The method of claim 18 wherein the default block vector is selected from a list of default block vectors consisting of
(−PUx−PUw, 0), (−PUx−2*PUw, 0), (−PUy−PUh, 0), (−PUy−2*PUh, 0), and (−PUx−PUw, −PUy−PUh),
where PUw and PUh are width and height of the prediction unit, respectively, and wherein PUx and PUy are the block position of PU relative to the top left position of the coding unit.
